(19) United States
(12) Patent Application Publication
(10) Pub. No.: US 2026/0257484 A1
(43) Pub. Date: Sep. 3, 2026

(54) LIQUID CONTAINER INCLUDING VALVE, ELASTIC MEMBER URGING THE VALVE, AND SWITCHING MECHANISM CONFIGURED TO SWITCH URGING FORCE WITH WHICH THE ELASTIC MEMBER URGES THE VALVE BETWEEN FIRST URGING FORCE AND SECOND URGING FORCE

(71) Applicant: BROTHER KOGYO KABUSHIKI KAISHA, Nagoya (JP)

(72) Inventors: Masahiro HAYASHI, Anjo (JP); Fumiya NAKAMURA, Nagoya (JP); Naoya OKAZAKI, Hashima (JP); Yuma TANABE, Nagoya (JP); Satoru OKI, Nagoya (JP); Yuji FUKUTA, Nagoya (JP)

(73) Assignee: BROTHER KOGYO KABUSHIKI KAISHA, Nagoya (JP)

(21) Appl. No.: 19/656,195

(22) Filed: Apr. 23, 2026

Related U.S. Application Data
(63) Continuation of application No. PCT/JP2024/038479, filed on Oct. 29, 2024.

(30) Foreign Application Priority Data
Nov. 7, 2023 (JP) 2023-190445

(51) Int. Cl. B41J 2/175

(52) U.S. Cl. CPC B41J 2/17523; B41J 2/17553; B41J 2/17596

(57) ABSTRACT

A liquid container includes a body, a valve, a liquid supply port, an elastic member, and a switching mechanism. The valve is positioned inside the body. The valve is movable between a closed position and an open position. The elastic member urges the valve to the closed position. The switching mechanism is configured to switch an urging force with which the elastic member urges the valve between a first urging force and a second urging force. The second urging force is smaller than the first urging force.

### REFERENCE TO RELATED APPLICATIONS

This is a by-pass continuation application of International Application No. PCT/JP2024/038479 filed on October 29, 2024 which claims priority from Japanese Patent Application No. 2023-190445 filed on November 7, 2023. The entire content of the priority application is incorporated herein by reference.

### TECHNICAL FIELD

The present disclosure relates to a liquid container configured to store liquid.

### BACKGROUND ART

A known liquid bottle stores ink and includes: a main body; a seal; a valve; and a coil spring. The main body has a cylindrical shape and has a supply port at the distal end of the main body. The seal has an annular shape and is positioned at the supply port. The valve is positioned inside an inner space of the main body. The coil spring urges the valve toward the seal. When a cylindrical portion of an ink tank is inserted into the supply port of the liquid bottle through the seal, the valve moves from a closed position where the valve closes the supply port to an open position where the supply port is open against a urging force of the coil spring. Accordingly, ink inside the main body flows into the inside of the ink tank through the inner space of the supply port and the inner space of the cylindrical portion. At the same time, air in the ink tank flows into the inside of the main body through the inner space of the cylindrical portion and the inner space of the supply port. Since gas-liquid exchange is performed between the liquid bottle and the ink tank as described above, the supply of ink is performed.

### SUMMARY

For example, in a case where the valve moves against the urging force of the coil spring due to an impact during transportation of the liquid bottle or the like, ink in the liquid bottle possibly leak from the supply port. In order to solve this problem, it is conceivable to increase the urging force of the coil spring. However, in this case, there is a possibility that the liquid bottle connected to the ink tank is pushed out by the urging force of the coil spring. Hence, in this configuration, it is difficult to supply ink from the liquid bottle to the ink tank.

In view of the foregoing, it is an object of the present disclosure to provide a liquid container in which liquid is less likely to leak from a liquid supply port except during a connection operation with a tank, and in which the connection with the tank is less likely to be released during the connection operation with the tank.

In order to attain the above and other objects, according to one aspect, the present disclosure provides a liquid container including a body, a valve, a liquid supply port, an elastic member, and a switching mechanism. The body defines a storage chamber configured to store liquid. The valve is positioned inside the body. The valve is movable between a closed position and an open position. The liquid supply port provides communication between an inside of the storage chamber and an outside of the storage chamber in a movement direction in which the valve moves. The liquid supply port is closed when the valve is at the closed position. The liquid supply port is open when the valve is at the open position. The elastic member urges the valve to the closed position. The switching mechanism includes a first spring seat supporting the elastic member, and a support member supporting the first spring seat. In the liquid container: the switching mechanism has a cylindrical shape and extends in the movement direction; and the switching mechanism is configured to switch an urging force with which the elastic member urges the valve between a first urging force and a second urging force. The second urging force is smaller than the first urging force.

According to another aspect, the present disclosure also provides, a liquid container including a body, a valve, a liquid supply port, an elastic member, and a switching mechanism. The body defines a storage chamber configured to store liquid. The valve is positioned inside the body. The valve is movable between a closed position and an open position. The liquid supply port provides communication between an inside of the storage chamber and an outside of the storage chamber in a movement direction in which the valve moves. The liquid supply port is closed when the valve is at the closed position. The liquid supply port is open when the valve is at the open position. The elastic member urges the valve to the closed position. In the liquid container: the switching mechanism is configured to switch an urging force with which the elastic member urges the valve between a first urging force and a second urging force. The second urging force is smaller than the first urging force.

In the above structures, the urging force can be switched between the first urging force and the second urging force. Hence, the likelihood of liquid leakage from the liquid supply port can be reduced except during performing the connection operation of the liquid container to the tank. Also, the likelihood of disconnection of the liquid container from the tank can be reduced during performing the connection operation of the liquid container to the tank.

### BRIEF DESCRIPTION OF DRAWINGS

FIG. 1 is an external perspective view of a multifunctional peripheral.

FIG. 2 is a vertical cross-sectional view schematically illustrating an internal structure of a printer section.

FIG. 3 is a plan view illustrating an arrangement of a carriage and an ink tank.

FIG. 4 is a perspective view of an ink tank set.

FIG. 5 is a perspective view of the ink tank.

FIG. 6 is a vertical cross-sectional view of the ink tank set taken along a plane having an ink chamber.

FIG. 7 is a perspective view of an ink bottle.

FIG. 8 is a schematic view illustrating the external shape of a protrusion.

FIG. 9 is a perspective view of a rubber.

FIG. 10 is another perspective view of the rubber.

FIG. 11 is a perspective view of a support member.

FIG. 12 is another perspective view of the support member.

FIG. 13 is a perspective view of a valve.

FIG. 14 is a vertical cross-sectional view of the ink bottle in a state where a valve is at a closed position.

FIG. 15 is a vertical cross-sectional view of the ink bottle in a state where the valve is at an open position.

FIG. 16 is a vertical cross-sectional view illustrating a state in which the ink bottle is connected to the ink tank set.

FIG. 17 is a cross-sectional view of a valve at an open position and the support member, taken along a plane having the portion where a rear inner curved surface of the support member is located.

FIG. 18 is a perspective view of the valve.

FIG. 19 is a perspective view of a spring seat.

FIG. 20 is a horizontal cross-sectional view of a switching mechanism, illustrating a state where a front guide piece is in contact with a front contact surface.

FIG. 21 is a horizontal cross-sectional view of the switching mechanism, illustrating a state where the front guide piece faces a front guide slit in an up-down direction.

FIG. 22 is a side view of a cap unit in which the valve, the coil spring, and the switching mechanism are attached to a bottle cap.

FIG. 23 is a cross-sectional view taken along line A-A in FIG. 22.

FIG. 24 is a schematic view illustrating a switching mechanism.

FIG. 25 is a schematic view illustrating a switching mechanism.

FIG. 26 is a schematic view illustrating a switching mechanism.

FIG. 27 is a schematic view illustrating a switching mechanism.

### DESCRIPTION

Hereinafter, an embodiment of the present disclosure will be described. It should be understood that the following embodiment is merely an example of the disclosure, and that this embodiment may be modified as appropriate without departing from the spirit of the disclosure. In the following description, a direction from the starting point to the end point of one of one-headed arrows, which constitute a double-headed arrow, is referred to as an orientation, both directions of the double-headed arrow are collectively referred to as a direction. In other words, the orientation is a component of the direction. Both an upward orientation and a downward orientation are components of an up-down direction and are opposite to each other. Both a leftward orientation and a rightward orientation are components of a left-right direction and are opposite to each other. Both a frontward orientation and a rearward orientation are components of a front-rear direction and are opposite to each other. Also, in this embodiment, the up-down direction corresponds to the direction of gravity, and the front-rear direction and the left-right direction correspond to the horizontal direction.

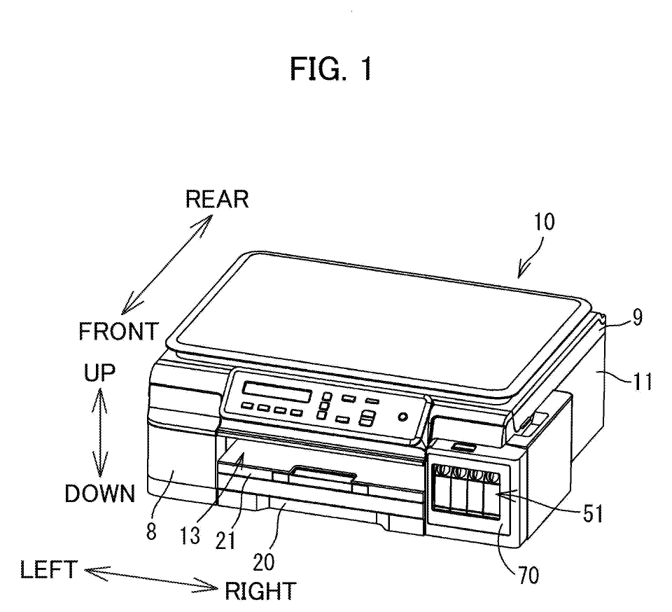

Further, the up-down direction is defined based on a state or an orientation of a multifunction peripheral 10 which is placed and ready for use. The front-rear direction is defined based on the assumption that the portion of the multifunction peripheral 10 in which an opening 13 is disposed is a front portion. The left-right direction is defined based on the perspective of a user viewing the multifunction peripheral 10 from the front portion. The state of the multifunction peripheral 10 illustrated in FIG. 1 will be sometimes referred to as the “usable state”. The orientation of the multifunction peripheral 10 illustrated in FIG. 1 will be sometimes referred to as the “usable orientation”. The front surface of the multifunction peripheral 10 is at the front portion of the multifunction peripheral 10, at which the opening 13 is disposed.

Overall Configuration of the Multifunction Peripheral 10

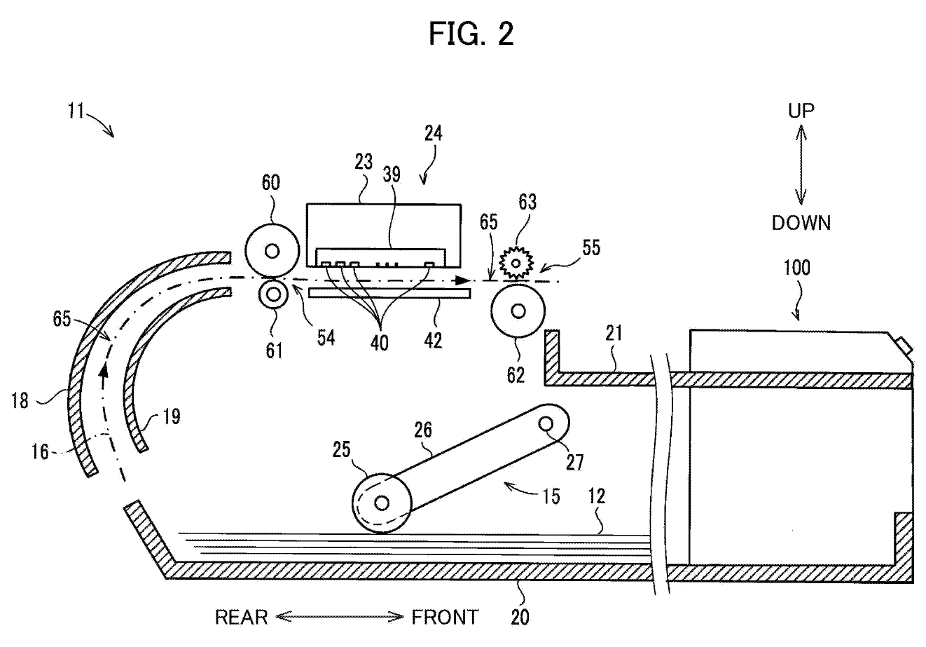

As illustrated in FIG. 1, the multifunction peripheral 10 includes a casing 8 having a generally rectangular-parallelepiped shape. The multifunction peripheral 10 includes a scanning section 9 and a printer section 11 in the inner space of the casing 8. The scanning section 9 is positioned at the upper portion of the inner space of the casing 8. The scanning section 9 has a scanning function. The printer section 11 is positioned below the scanning section 9 in the inner space of the casing 8. The printer section 11 has a printing function. The printer section 11 is configured to record an image on a sheet 12 illustrated in FIG. 2 based on an inkjet recording method. As illustrated in FIGS. 1 and 2, the printer section 11 includes a feeding section 15, a feeding tray 20, a discharging tray 21, a conveying path 65, a conveying roller section 54, a recording section 24, a discharging roller section 55, a platen 42, and an ink tank set 51.

The Feeding Tray 20 and the Discharging Tray 21

As illustrated in FIG. 1, the opening 13 is located at the center in the left-right direction of the front surface of the multifunction peripheral 10. The feeding tray 20 is movable in the front-rear direction through the opening 13 with user’s operation. As illustrated in FIG. 2, the feeding tray 20 is configured to support the sheets 12 stacked on the feeding tray 20. The discharging tray 21 is positioned above the feeding tray 20. The discharging tray 21 is movable together with the feeding tray 20 in the front-rear direction. The discharging tray 21 is configured to support the sheets 12 discharged by the discharging roller section 55.

The Feeding Section 15

The feeding section 15 is configured to convey the sheets 12 supported on the feeding tray 20 to the conveying path 65. As illustrated in FIG. 2, the feeding section 15 includes a feeding roller 25, a feeding arm 26, and a shaft 27. The feeding roller 25 is rotatably supported by the feeding arm 26 at the end portion of the feeding arm 26. Since a drive force is transmitted from a conveying motor (illustration is omitted) to the feeding roller 25, the feeding roller 25 is rotated in a direction and therefore the sheet 12 is conveyed in a conveying direction 16. Hereinafter the rotations of the feeding roller 25, a conveying roller 60, and a discharging roller 62 in the direction each of which conveys the sheet 12 in the conveying direction 16 are referred to as a “frontward rotation”. The feeding arm 26 is pivotally movably supported by the shaft 27 supported by the frame of the printer section 11. The feeding arm 26 is urged by its own weight or by an elastic force generated with a spring or the like so as to pivotally move toward the feeding tray 20.

The Conveying Path 65

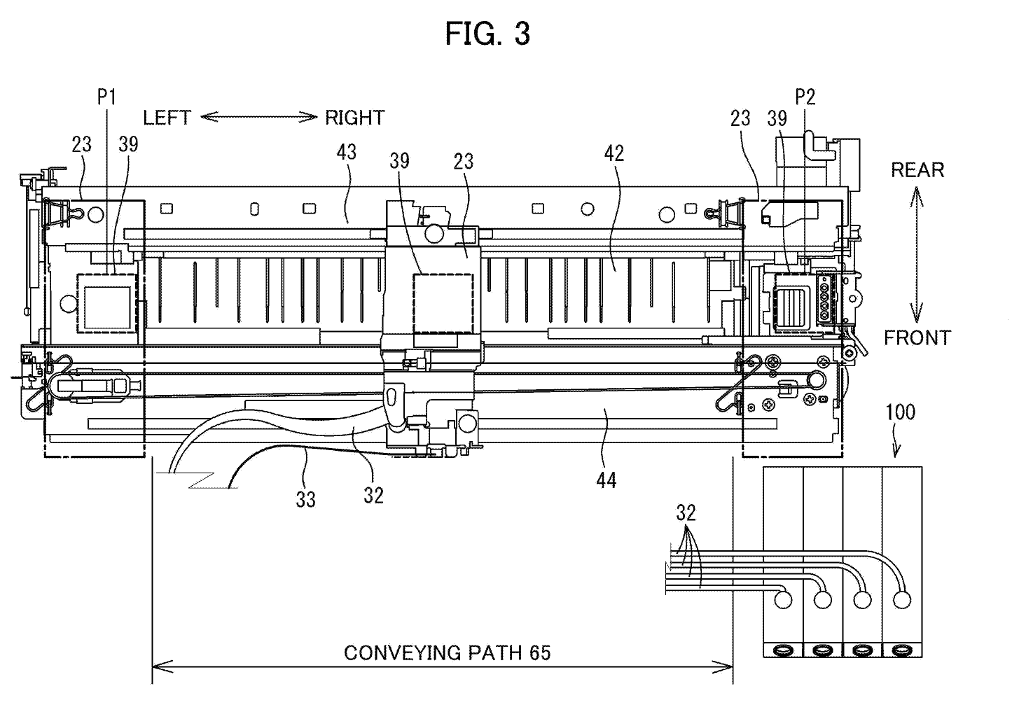

As illustrated in FIG. 2, the conveying path 65 refers to a space which is defined by an outer guide member 18 and an inner guide member 19 facing each other at a predetermined interval, for example. The conveying path 65 extends from the rear end portion of the feeding tray 20 to the rear portion of the printer section 11, and extends from the bottom to the top at the rear portion of the printer section 11 while the conveying path 65 is curved in a U-turn. Then, the conveying path 65 extends to the discharging tray 21 through a space between the recording section 24 and the platen 42. As illustrated in FIGS. 2 and 3, the portion of the conveying path 65 between the conveying roller section 54 and the discharging roller section 55 is located approximately at the center of the multifunction peripheral 10 in the left-right direction, and extends in the front-rear direction. In FIG. 2, the conveying direction 16 of the sheet 12 in the conveying path 65 is indicated with a one-dot chain arrow.

The Conveying Roller Section 54

As illustrated in FIG. 2, the conveying roller section 54 is positioned upstream of the recording section 24 in the conveying direction 16. The conveying roller section 54 includes the conveying roller 60 and a pinch roller 61. The conveying roller 60 and the pinch roller 61 face each other in the up-down direction. Since a drive force of the conveying motor is transmitted to the conveying roller 60, the conveying roller 60 is rotated. The pinch roller 61 is rotated in accordance with the rotation of the conveying roller 60. Since the conveying roller 60 is rotated frontward by the frontward rotation of the conveying motor, the sheet 12 is nipped between the conveying roller 60 and the pinch roller 61 and is conveyed in the conveying direction 16.

The Discharging Roller Section 55

As illustrated in FIG. 2, the discharging roller section 55 is positioned downstream of the recording section 24 in the conveying direction 16. The discharging roller section 55 includes the discharging roller 62 and a spur 63. The discharging roller 62 and the spur 63 face each other in the up-down direction. Since a drive force of the conveying motor is transmitted to the discharging roller 62, the discharging roller 62 is rotated. The spur 63 is rotated in accordance with the rotation of the discharging roller 62. Since the discharging roller 62 rotates frontward by the frontward rotation of the conveying motor, the sheet 12 is nipped between the discharging roller 62 and the spur 63 and is conveyed in the conveying direction 16.

The Recording Section 24

As illustrated in FIG. 2, the recording section 24 is positioned between the conveying roller section 54 and the discharging roller section 55 in the conveying direction 16. The recording section 24 faces the platen 42 in the up-down direction. The conveying path 65 is between the recording section 24 and the platen 42 in the up-down direction. The recording section 24 is positioned above the conveying path 65 in the up-down direction. The recording section 24 includes a carriage 23 and a recording head 39.

As illustrated in FIG. 3, the carriage 23 is supported by guide rails 43 and 44. The guide rails 43 and 44 are supported by the frame of the printer section 11. The guide rails 43 and 44 are apart from each other in the front-rear direction. Each of the guide rails 43 and 44 extends in the left-right direction. In the left-right direction, each of the guide rails 43 and 44 extends outward of the conveying path 65. That is, each guide rails 43 and 44 has left end portion and the right end portion which are located outward of the conveying path 65 in the left-right direction. The carriage 23 is mounted to a known belt mechanism disposed at the guide rail 44. Since a drive force is transmitted from a carriage motor (illustration is omitted) to the belt mechanism, the belt mechanism is rotated. Since the belt mechanism is rotated, the carriage 23 moves in the left-right direction. In FIG. 3, the movement range of the carriage 23 is indicated with a one-dot chain line. The carriage 23 is configured to move rightward of the conveying path 65 in the left-right direction and is configured to move leftward of the conveying path 65 in the left-right direction.

The ink tank 100 and the recording head 39 are connected to each other by ink tubes 32. A control board on which a control unit is mounted and the recording head 39 are electrically connected to each other by a flexible flat cable 33. Note that the illustration of the control board is omitted. The ink tubes 32 and the flexible flat cable 33 extend from the carriage 23. The ink tubes 32 are configured to supply ink stored in an ink tank 100 to the recording head 39. The flexible flat cable 33 is configured to transmit control signals output from the control unit to the recording head 39.

As illustrated in FIGS. 2 and 3, the recording head 39 is mounted on the carriage 23. The recording head 39 is movable between a standby position P1 and a maintenance position P2 in the left-right direction by the movement of the carriage 23. The standby position P1 is positioned leftward of the conveying path 65. The left is an example of the opposite side. The maintenance position P2 is positioned rightward of the conveying path 65. Multiple nozzles 40 are positioned at the lower surface of the recording head 39. The recording head 39 is configured to eject ink from the nozzles 40 in the form of minute ink droplets. In a process where the carriage 23 moves, the recording head 39 ejects ink droplets to the sheet 12 supported by the platen 42. Accordingly, an image is recorded on the sheet 12.

The Platen 42

As illustrated in FIGS. 2 and 3, the platen 42 is positioned between the conveying roller section 54 and the discharging roller section 55 in the conveying direction 16. The platen 42 faces the recording section 24 in the up-down direction. The platen 42 is configured to support the sheet 12 conveyed by the conveying roller section 54 from below.

The Ink Tank Set 51

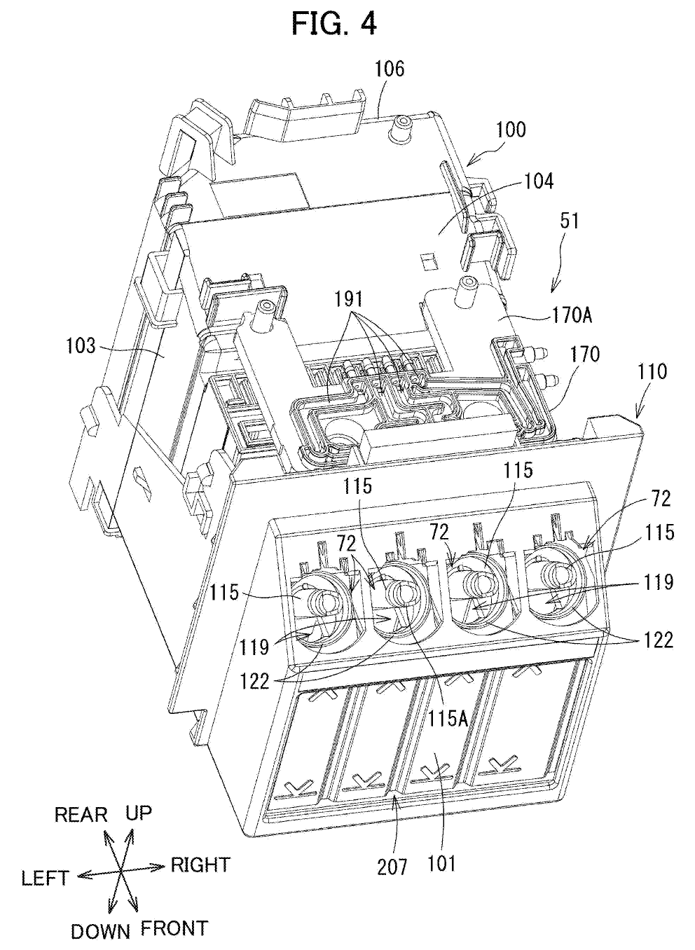

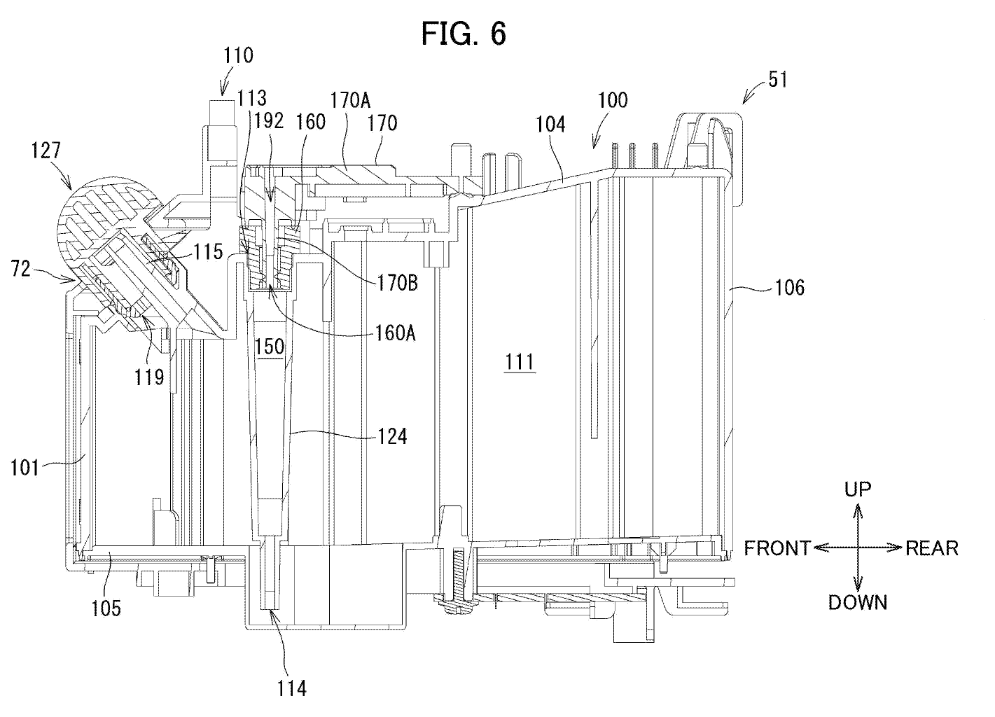

As illustrated in FIGS. 4 and 6, the ink tank set 51 includes the ink tank 100, a tank cover 110, and tank caps 127. The ink tank 100 is an example of the tank. Note that the illustrations of the tank caps 127 are omitted in FIG. 4. As illustrated in FIG. 1, the ink tank set 51 is positioned in the inside of the multifunction peripheral 10. The ink tank set 51 is fixed to the multifunction peripheral 10 such that a user cannot detach the ink tank set 51 easily from the multifunction peripheral 10. In the left-right direction, an opening is positioned at the right end of the front surface of the casing 8 of the multifunction peripheral 10. The ink tank set 51 is positioned rearward of the opening of the casing 8. In other words, in the internal space of the casing 8, the ink tank set 51 is positioned rightward of the center in the left-right direction of the casing 8.

A cover 70 is disposed on the casing 8. The cover 70 is positioned frontward of the opening of the casing 8. The cover 70 is pivotally movable about a pivot shaft. The pivot shaft is positioned at the lower end of the casing 8 in the up-down direction and extends in the left-right direction. The cover 70 is pivotally movable from a covering position illustrated in FIG. 1 to an exposing position. At the covering position, the cover 70 covers the opening of the casing 8. At the exposing position, the opening of the casing 8 is exposed to the outside of the multifunction peripheral 10. In other words, the cover 70 is pivotally movable from the covering position illustrated in FIG. 1, where the cover 70 covers the ink tank set 51, and the exposing position, where the ink tank set 51 is exposed to the outside of the multifunction peripheral 10. The cover 70 has an opening. Even when the cover 70 is positioned at the covering position, part of the ink tank set 51 is exposed to the outside of the multifunction peripheral 10 through the opening of the cover 70. Here, “part of the ink tank set 51 is exposed to the outside of the multifunction peripheral 10 through the opening of the cover 70” signifies that a user can see at least part of the ink tank set 51 through the opening of the cover 70 and does not signify that part of the ink tank set 51 protrudes toward the outside of the multifunction peripheral 10 through the opening of the cover 70.

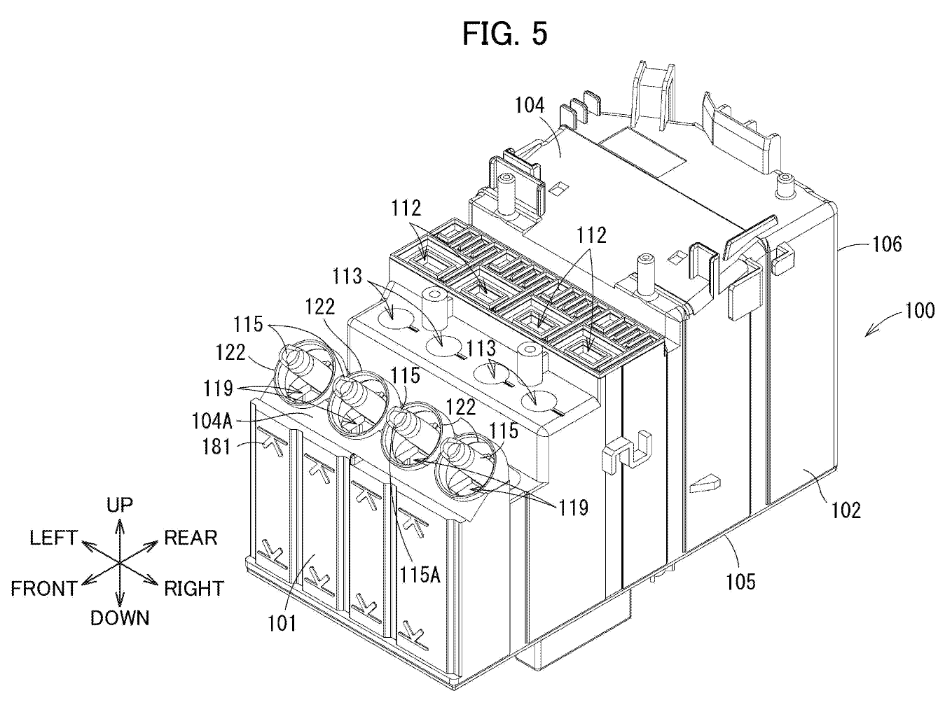

As illustrated in FIGS. 5 and 6, the ink tank 100 includes four ink chambers 111 inside the ink tank 100. The four ink chambers 111 are arranged in the left-right direction. The four ink chambers 111 respectively store yellow ink, cyan ink, magenta ink, and black ink. The ink tank 100 includes a front wall 101, a right wall 102, a left wall 103, an upper wall 104, a lower wall 105, and a rear wall 106. The inner space of the ink tank 100 is partitioned into the four ink chambers 111 by three partition walls arranged in the left-right direction at intervals.

The upper wall 104 has air communication ports 112. Each air communication port 112 provides communication between the corresponding ink chamber 111 and the outside of the ink tank 100. The air communication ports 112 extend through the upper wall 104 in the up-down direction. The upper surface of the upper wall 104 has a sloped surface 104A. The sloped surface 104A is positioned at the front-end portion of the upper surface of the upper wall 104. The sloped surface 104A is sloped relative to the front-rear direction such that the sloped surface 104A extends downward as the sloped surface 104A extends frontward. The sloped surface 104A extends from the left edge of the ink tank 100 to the right edge of the ink tank 100.

The upper wall 104 has four openings 113. Each opening 113 provides communication between the corresponding ink chamber 111 and the outside of the ink tank 100. The four openings 113 are positioned frontward of the air communication ports 112. The four openings 113 are arranged in the left-right direction at intervals.

As illustrated in FIG. 6, each opening 113 is connected to an outflow tube 124. Each outflow tube 124 is a cylindrical tube extending downward from the corresponding opening 113 in the up-down direction. Each outflow tube 124 has an outflow opening 114 at the lower end of the outflow tube 124. Each outflow opening 114 opens downward.

In each outflow tube 124, a sealing member 160 is press-fitted through the corresponding opening 113. Each sealing member 160 has a through-hole 160A extending in the up-down direction.

As illustrated in FIGS. 4 and 6, each outflow tube 124 is connected to a connecting portion 170 disposed on the upper surface of the upper wall 104. The connecting portion 170 has a board 170A and four cylindrical portions 170B. The board 170A has a flat shape. The board 170A is fixed to the upper wall 104 such that the board 170A is attachable to and detachable from the upper wall 104. Each cylindrical portion 170B has a cylindrical shape and extends downward from the board 170A in the up-down direction. Four grooves through which ink can flow are positioned on the upper surface of the board 170A. The board 170A has four first ink flow passages 191. The first ink flow passages 191 are defined by the four grooves and a film affixed to the upper surface of the board 170A. Note that the illustration of the film is omitted in FIGS. 4 and 6. Each first ink flow passage 191 is connected to the corresponding one of the ink tubes 32, connected to the recording head 39. Each cylindrical portion 170B has a second ink flow passage 192 through which ink can flow. Each second ink flow passage 192 is in communication with the corresponding one of the first ink flow passages 191. Each cylindrical portion 170B is inserted in the corresponding through-hole 160A of the sealing member 160 in a liquid-tight manner. Accordingly, each second ink flow passage 192 is in communication with an outflow passage 150 of the corresponding outflow tube 124. Ink stored in each ink chamber 111 flows to the recording head 39 through the corresponding outflow tube 124, the corresponding second ink flow passage 192, the corresponding first ink flow passage 191, the corresponding ink tube 32. When ink, stored in the ink chambers 111, is used due to ejection of ink from the recording head 39, air flows into the ink chambers 111 through the air communication ports 112.

Circular-shaped walls 122 are positioned at the front-end portion of the upper wall 104. Each circular-shaped wall 122 has a cylindrical shape and surrounds the corresponding one of the communication ports 119 and the corresponding one of the tank tubes 115. Each circular-shaped wall 122 extends diagonally upward and frontward from the front-end portion of the upper wall 104 in an extending direction crossing both the direction of gravity and the horizontal direction. Each circular-shaped wall 122 extends parallel to the corresponding one of the tank tubes 115. Each tank tube 115 protrudes further upward than the distal edge of the corresponding circular-shaped wall 122.

Each tank tube 115 is positioned inside the corresponding circular-shaped wall 122. Each tank tube 115 is a circular tube extending upward and frontward beyond the upper wall 104 in the extending direction, which crosses both the direction of gravity and the horizontal direction. Each tank tube 115 has an upper end which is open in the outside of the corresponding ink chamber 111. Each tank tube 115 has a lower end which is open in the inside of the corresponding ink chamber 111. Each tank tube 115 has an inner space providing communication between the outside and inside of the corresponding ink chamber 111. Each tank tube 115 is positioned rearward of the center of the corresponding circular-shaped wall 122. In other words, the axes each of which extends through the center of the corresponding tank tube 115 are positioned rearward of the axes each of which extends through the center of the corresponding circular-shaped wall 122 when viewed in the extending direction, in which the tank tubes 115 extend. The distal end of each tank tube 115 is divided in the left-right direction into two lip portions. Since the distal end of each tank tube 115 is divided in the left-right direction into two lip portions, gaps are located in the upper portion and the lower portion of the distal end of the tank tube 115.

Each communication port 119 is positioned inside the corresponding circular-shaped wall 122 of the sloped surface 104A. The communication ports 119 extend through the upper wall 104 in the up-down direction. The front portion of each communication port 119 has a circular shape, and the rear portion of each communication port 119 has a rectangular shape. In other words, each communication port 119 has a quadrilateral shape whose front portion is convex outward in an arc shape. Each communication port 119 provides communication between the outside and inside of the corresponding ink chamber 111. Each communication port 119 is positioned frontward of the corresponding tank tube 115. Each communication port 119 is positioned below the corresponding tank tube 115. In other words, straight lines each of which passes through the center of the corresponding communication port 119 and extends in the extending direction, in which the tank tubes 115 extend, are positioned frontward of the axes of the tank tubes 115, each of which passes through the center of the corresponding tank tube 115, when viewed in the extending direction, in which the tank tubes 115 extend. Each communication port 119 is positioned frontward of the center of the corresponding circular-shaped wall 122. In other words, each straight line, passing through the center of the corresponding communication port 119 and extends in the extending direction, is positioned frontward of the corresponding axis of the circular-shaped wall 122, passing through the center of the circular-shaped wall 122, when viewed in the extending direction, in which the circular-shaped walls 122 extend. Each communication port 119 is an example of the liquid inlet.

As illustrated in FIG. 4, the tank cover 110 holds the ink tank 100 while the tank cover 110 covers the front portion of the ink tank 100 from the front. The tank cover 110 has an opening 207. Part of the front wall 101 of the ink tank 100 is exposed to the front of the tank cover 110 through the opening 207. Here, “part of the front wall 101 of the ink tank 100 is exposed to the front of the tank cover 110 through the opening 207” signifies that at least a user can see part of the front wall 101 from the front of the tank cover 110 through the opening 207, and does not signify that part of the front wall 101 protrudes frontward of the tank cover 110 through the opening 207.

The tank cover 110 has four through-holes 72. The four through-holes 72 are arranged in the left-right direction at intervals. Each through-hole 72 faces the corresponding communication port 119 in an extending direction. Each tank tube 115 can be visually recognized through the corresponding through-hole 72. Each communication port 119 can be visually recognized through the corresponding through-hole 72. The sloped wall 206 has an inner peripheral surface defining the four through-holes 72. Hereinafter, the inner peripheral surface defining the through-hole 72 will be called the “inner peripheral surface of the through-hole 72”. The inner peripheral surface of each through-hole 72 surrounds the corresponding circular-shaped wall 122 when viewed in the extending direction. Each of the four through-holes 72 is positioned so as to correspond to the respective one of the ink chambers 111A, 111B, 111C, and 111D. That is, each of the four through-holes 72 overlaps the corresponding one of the four ink chambers 111A, 111B, 111C, and 111D when viewed in the extending direction. As illustrated in FIG. 6, each tank tube 115 protrudes to the outside of the tank cover 110 through the corresponding through-hole 72. Each through-hole 72 has a shape such that a bottle cap 82 described later of the ink bottle 80 can be inserted into the corresponding through-hole 72. Each through-hole 72 is an example of the connection port.

As illustrated in FIG. 6, tank caps 127 are detachably attachable to the circular-shaped walls 122. Each tank cap 127 is a cylindrical member whose one end is closed. In a state where the tank caps 127 are detached from the corresponding circular-shaped wall 122, the tank caps 127 are not connected to both the ink tank 100 and the tank cover 110 and are completely separated from both the ink tank 100 and the tank cover 110. That is, the ink tank set 51 does not include a holding member, which includes an arm or other members, for holding the tank caps 127 detached from the corresponding circular-shaped walls 122 in a connected state where the tank caps 127 are connected to the ink tank 100 or the tank cover 110.

Ink Bottle 80

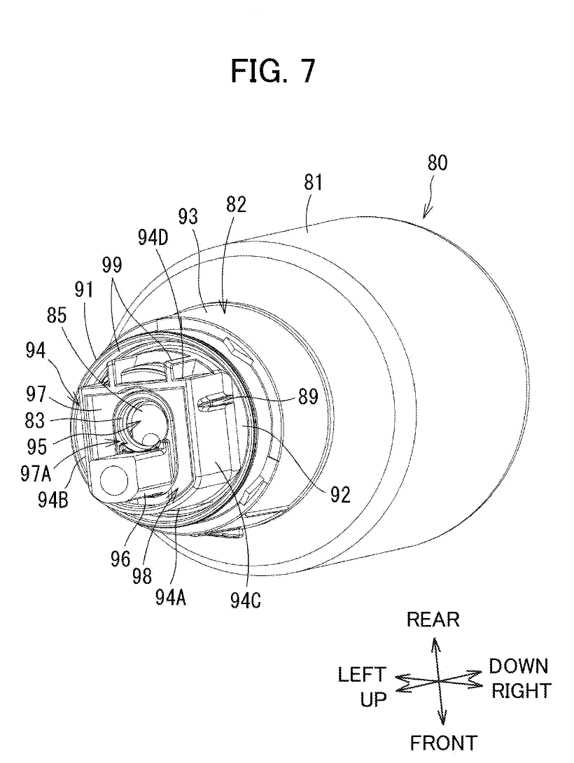

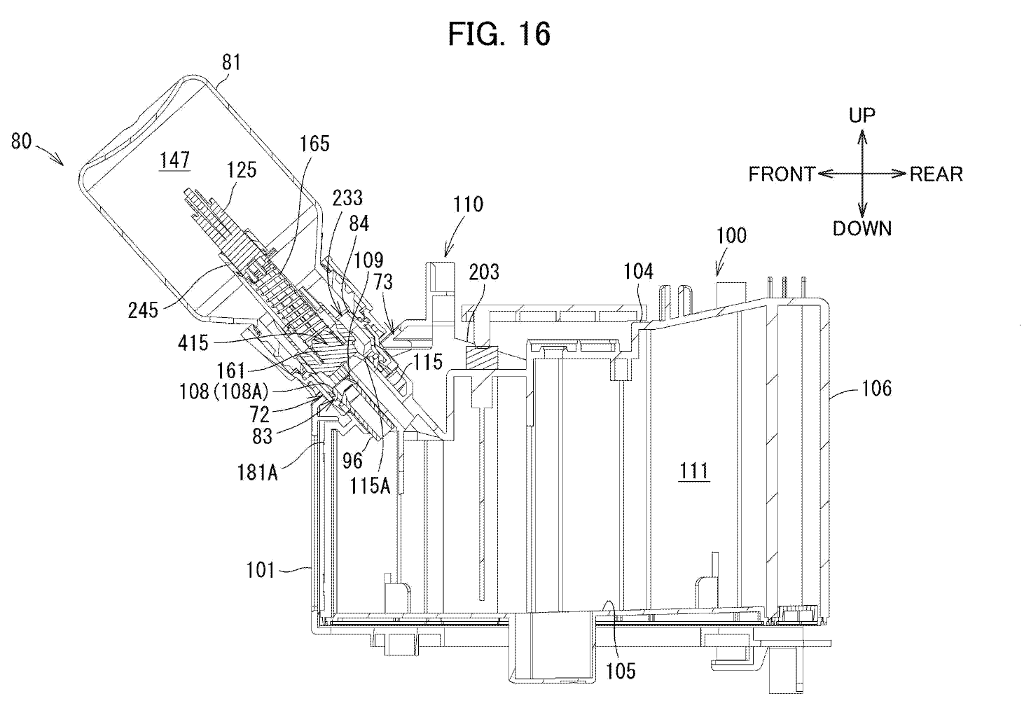

As illustrated in FIGS. 7 and 16, the ink bottle 80 is configured to be connected to the ink tank set 51. The ink bottle 80 is an example of the liquid container. As illustrated in FIGS. 7, 14, and 16 the ink bottle 80 includes a bottle main body 81, the bottle cap 82, a support member 84 and a valve 161, a coil spring 165 and a switching mechanism 145. The bottle main body 81 has a cylindrical shape. The upper end of the bottle main body 81 opens. Specifically, the bottle main body 81 has a main body container 81A and an opening portion 87. The main body container 81A defines an ink storage chamber 147 storing ink. The opening portion 87 is connected to the upper end of the main body container 81A. The inner space of the opening portion 87 is in communication with the ink storage chamber 147. The upper end of the opening portion 87 opens upward. The diameter of the opening portion 87 is smaller than the diameter of the main body container 81A. The bottle main body 81 and the bottle cap 82 are examples of the main body. The ink storage chamber 147 is an example of the storage chamber. Ink is an example of the liquid. Ink may be a pigment ink containing a pigment or a dye ink containing a dye, for example. Each ink bottle 80 may store cleaning liquid containing water instead of ink. Cleaning liquid is an example of the liquid.

Since the opening portion 87 is press-fitted in the inner space of the bottle cap 82, the bottle cap 82 is detachably attached to the opening portion 87. Note that the bottle cap 82 may be detachably attached to the opening portion 87 due to the inner peripheral surface of the bottle cap 82 and the outer peripheral surface of the opening portion 87 being threadedly engaged with each other. The bottle cap 82 includes a side wall 93, a bottom wall 92, a protrusion 94, a rubber 83, a key member 99, and an annular rib 91. The side wall 93 is a cylindrical wall extending in the up-down direction. The side wall 93 is connected to the opening portion 87 by one or more screws. The bottom wall 92 is an annular wall extending inward in a radial direction from the upper end of the side wall 93.

The protrusion 94 is a cylindrical wall extending upward from the bottom wall 92. The protrusion 94 is configured to be inserted in the corresponding through-hole 72 of the tank cover 110. The shape of the outer peripheral surface of the protrusion 94 corresponds to the shape of the inner peripheral surface of the corresponding through-hole 72 of the tank cover 110. In other words, the shape and size of the outer peripheral surface of the protrusion 94 are approximately the same as the shape and size of the inner peripheral surface of the corresponding through-hole 72. That is, the shape of the outer peripheral surface of the protrusion 94 in an axial direction in which a center axis B1 of the protrusion 94 extends corresponds to the shape of the through-hole 72 in the axial direction. The front portion of the outer peripheral surface of the protrusion 94 has a circular shape and the rear portion of the outer peripheral surface of the protrusion 94 has a rectangular shape in which straight sides are connected. In other words, the outer peripheral surface of the protrusion 94 has a quadrilateral shape whose front portion is convex outward in an arc shape.

Specifically, the outer peripheral surface of the protrusion 94 has an outer curved surface 94A, a left outer flat surface 94B, a right outer flat surface 94C, and a rear outer flat surface 94D. The outer curved surface 94A is convex frontward. The left outer flat surface 94B is connected to the left end of the outer curved surface 94A. The right outer flat surface 94C is connected to the right end of the outer curved surface 94A. The rear outer flat surface 94D connects the rear end of the left outer flat surface 94B and the rear end of the right outer flat surface 94C to each other.

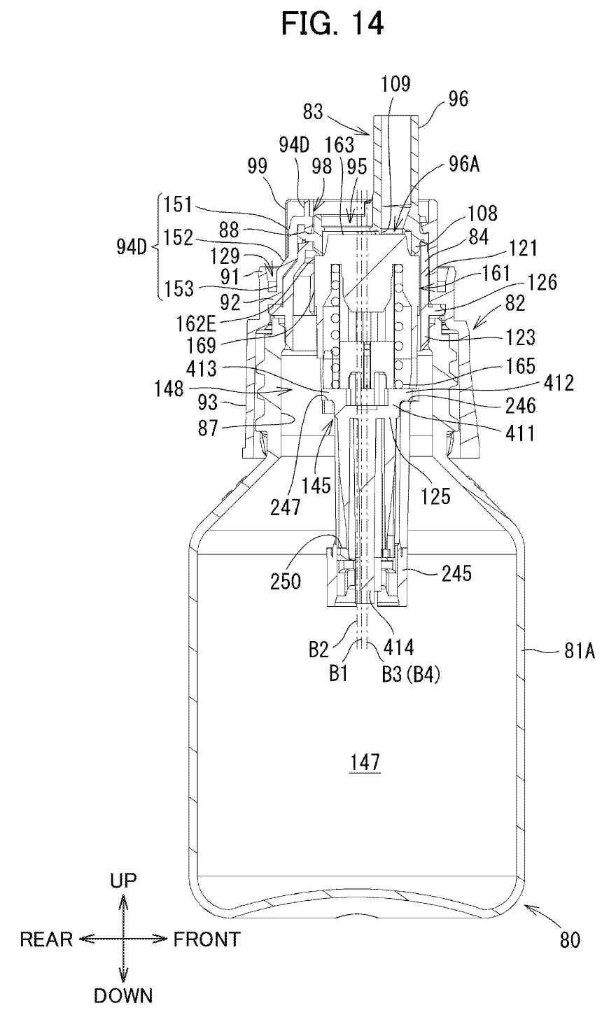

As illustrated in FIGS. 7 and 14, the rear outer flat surface 94D has an upper flat surface 151, a middle-sloped surface 152, and a lower arc-shaped surface 153. The upper flat surface 151 is positioned across the upper end portion of the protrusion 94 to the center of the protrusion 94 in the up-down direction. The middle-sloped surface 152 is continuous with the lower end of the upper flat surface 151. The middle-sloped surface 152 is sloped relative to the up-down direction such that the middle-sloped surface 152 extends rearward as the middle-sloped surface 152 extends downward. Accordingly, the inner space of the protrusion 94 expands such that the inner space of the protrusion 94 becomes larger to the rear as the inner space of the protrusion 94 approaches the lower. The lower arc-shaped surface 153 is positioned from the lower end of the middle-sloped surface 152 to the upper surface of the bottom wall 92. The lower arc-shaped surface 153 is an arc-shaped surface convex rearward when viewed from above. In a state where the protrusion 94 is inserted in the corresponding through-hole 72, the rear outer flat surface 94D corresponds to the rear portion of the inner peripheral surface of the corresponding through-hole 72.

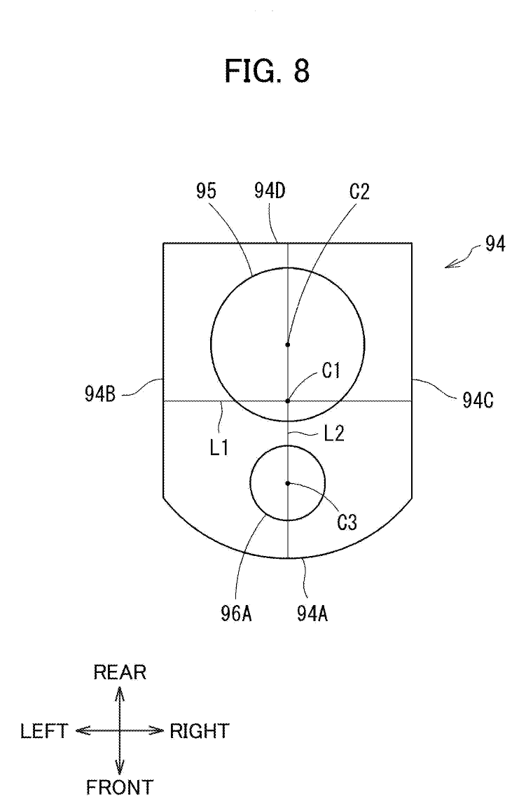

As illustrated in FIG. 8, the outer peripheral surface of the protrusion 94 in the axial direction does not have a rotational symmetry about a center C1 of the protrusion 94. The rotational symmetry signifies that an object coincides with itself two or more times when the object is rotated 360 degrees about its center as the rotational axis. For example, in a case where the outer peripheral surface of the protrusion 94 is an equilateral triangle, when the protrusion 94 is rotated 360 degrees about the center C1 as the rotational axis, the protrusion 94 coincides with itself three times. Hence, the outer peripheral surface of the protrusion 94 has the rotational symmetry about the center C1 of the protrusion 94. In the present embodiment, when the protrusion 94 is rotated 360 degrees about the center C1 as the rotational axis, the protrusion 94 coincides with itself only once. Hence the outer peripheral surface of the protrusion 94 does not have the rotational symmetry about the center C1. As a result, the protrusion 94 can be inserted into the corresponding through-hole 72 with just one orientation. The center C1 is a point at which the central point of a line segment defining the length of the protrusion 94 in the left–right direction and the central point of a line segment defining the length of the protrusion 94 in the front–rear direction coincide with each other when the protrusion 94 is viewed from above. In the present embodiment, the center C1 is a point at which the central point of a line segment L1 connecting the left outer flat surface 94B and the right outer flat surface 94C, and the central point of a line segment L2 connecting the front end of the outer curved surface 94A and the rear outer flat surface 94D coincide with each other when the protrusion 94 is viewed from above.

Ribs 89 protruding from the left outer flat surface 94B and protruding from the right outer flat surface 94C are provided on the protrusion 94. One of the ribs 89 is positioned rearward of the center in the front-rear direction of the left outer flat surface 94B. The one rib 89 extends in the up-down direction from the upper end portion of the 94B to the lower end portion of the left outer flat surface 94B. In a state where the protrusion 94 is inserted in the corresponding through-hole 72, the one rib 89 is in contact with the right portion of the inner peripheral surface of the through-hole 72. The other of the ribs 89 is positioned rearward of the center in the front-rear direction of the right outer flat surface 94C. The other rib 89 is positioned from the upper end portion of the right outer flat surface 94C to the lower end portion of the right outer flat surface 94C. In a state where the protrusion 94 is inserted in the corresponding through-hole 72, the other rib 89 is in contact with the left portion of the inner peripheral surface of the through-hole 72. Each of the ribs 89 is an example of a rib.

As illustrated in FIG. 14, the center axis B1 passing through the center C1 of the protrusion 94 is offset frontward relative to a center axis B2 passing through the center of the opening portion 87. In other words, the center C1 of the protrusion 94 is offset frontward relative to the center of the opening portion 87. A valve accommodating space 148 in which the valve 161 is accommodated is defined by the inner surface of the protrusion 94 and the opening portion 87.

As illustrated in FIG. 7, the protrusion 94 includes an upper wall 97 positioned at the upper end portion of the protrusion 94. The upper wall 97 is positioned slightly below the upper end of the protrusion 94. The upper wall 97 has an upper surface orthogonal to the up-down direction. The upper wall 97 has a flat plate shape extending in the front-rear direction and the left-right direction. A recessed portion 98 is defined by the upper surface of the upper wall 97 and the inner peripheral surface of the protrusion 94. The inner peripheral surface of the recessed portion 98 is parallel to the outer peripheral surface of the protrusion 94.

An opening 97A is located at the upper surface of the upper wall 97 of the protrusion 94. The opening 97A has an oblong shape extending in the front-rear direction. The opening 97A extends through the upper wall 97 in the up-down direction. The opening 97A is defined by the upper wall 97. Part of the rubber 83 is exposed to the outside through the opening 97A.

A protrusion 88 protruding downward from the upper wall 97 is provided on the protrusion 94. The protrusion 88 has an oblong shape and extends along the opening 97A.

The key member 99 extends rearward from the rear outer flat surface 94D of the outer peripheral surface of the protrusion 94. The cross-sectional shape of the key member 99 taken along a plane orthogonal to the up-down direction is not rotationally symmetrical about the center C1 of the protrusion 94. The position and shape of the key member 99 coincide with the position and shape of the key groove 74 of the corresponding through-hole 72 to which the corresponding ink bottle 80 is connected. In other words, the four liquid bottles 80 respectively store inks of different colors from one another, the colors being selected from black, yellow, cyan, and magenta. In the four liquid bottles 80, the positions and shapes of the key members 99 relative to the respective rear outer flat surfaces 94D are different from one another. In FIG. 7, the key member 99 of the ink bottle 80 which coincides with the leftmost through-hole 72 of the tank cover 110 is illustrated.

The annular rib 91 is positioned at the outer peripheral portion of the upper surface of the bottom wall 92. The annular rib 91 is spaced outward from the protrusion 94. The annular rib 91 protrudes upward from the upper surface of the bottom wall 92. The annular rib 91 extends in an annular shape along the outer peripheral portion of the upper surface of the bottom wall 92. The annular rib 91 surrounds the outer peripheral surface of the protrusion 94. Accordingly, an ink holding space 129 is defined by the inner peripheral surface of the annular rib 91, the outer peripheral surface of the protrusion 94, and the upper surface of the bottom wall 92. The ink holding space 129 has an annular shape.

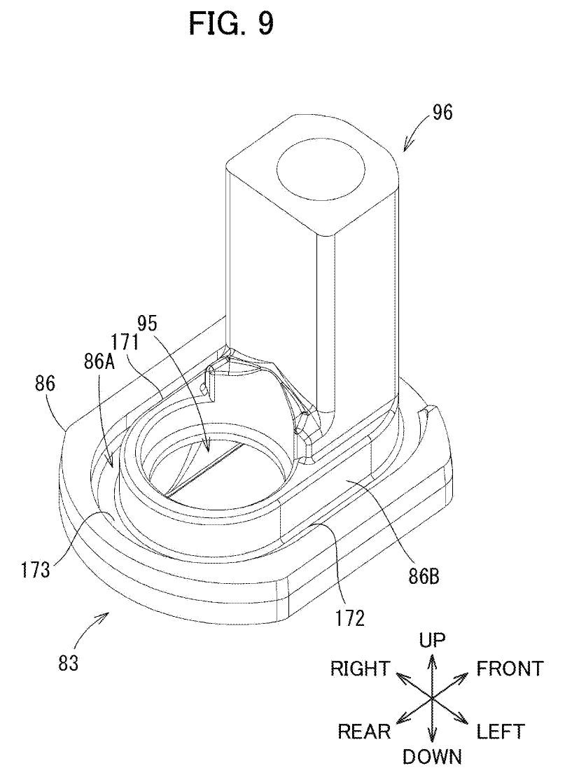

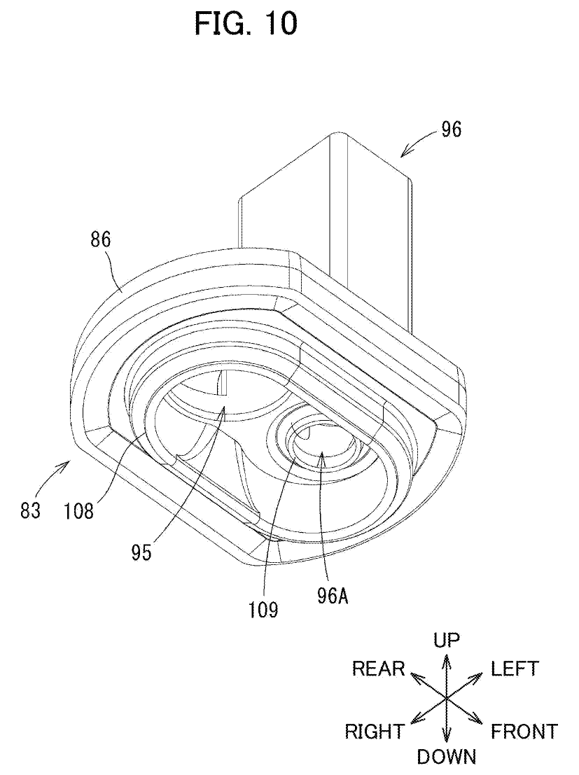

As illustrated in FIGS. 7 and 14, the rubber 83 is positioned at the opening 97A of the upper wall 97 of the protrusion 94. The rubber 83 is made of rubber. As illustrated in FIGS. 9 and 10, the rubber 83 has a base portion 86, an opening 95, and a bottle tube 96. The base portion 86 has an oblong shape, in which the ends of the base portion 86 in the front-rear direction are curved and the ends of the base portion 86 in the left-right direction extends linearly in the front-rear direction. A groove 86A is located at the upper surface of the base portion 86. The groove 86A extends along the shape of the base portion 86 and has an oblong shape. The groove 86A is recessed downward from the upper surface of the base portion 86.

Specifically, the groove 86A has a right straight groove 171, a left straight groove 172, and a rear curved groove 173. The right straight groove 171 is located at the right portion of the peripheral end of the base portion 86. The right straight groove 171 extends in the front-rear direction. The left straight groove 172 is located at the left portion of the peripheral end of the base portion 86. The left straight groove 172 extends in the front-rear direction. The right straight groove 171 and the left straight groove 172 face each other in the left-right direction such that the opening 95 and the bottle tube 96 are positioned between the right straight groove 171 and the left straight groove 172. The rear curved groove 173 is located at the rear portion of the peripheral end of the base portion 86. The rear curved groove 173 is connected to both the rear end of the right straight groove 171 and the rear end of the left straight groove 172. The protrusion 88 is fitted in the groove 86A. Each of the right straight groove 171 and the left straight groove 172 receives outward force in the left-right direction from the protrusion 88. As a result, the base portion 86 is maintained in a state where the base portion 86 is urged outward in the left-right direction.

The base portion 86 has a protrusion 86B positioned inward of the groove 86A and protrudes upward. The protrusion 86B has an oblong shape, in which the ends of the protrusion 86B in the front-rear direction are curved and the ends of the protrusion 86B in the left-right direction extends linearly in the front-rear direction. The protrusion 86B is received in the opening 97A of the bottle cap 82.

The opening 95 has a circular shape and extends through the protrusion 86B in the up-down direction. The opening 95 provides communication between the valve accommodating space 148 of the ink bottle 80 and the outside.

The bottle tube 96 has an opening 96A. The bottle tube 96 is adjacent to the opening 95 and positioned frontward of the opening 95. The bottle tube 96 extends upward from the protrusion 86B. The bottle tube 96 has a cylindrical body having an opening which is open upward and an opening which is open downward. The inner space of the bottle tube 96 connects the inner space of the ink bottle 80 and the outside to each other.

The outer shape of the bottle tube 96 has a quadrilateral shape corresponding to the shape of the communication port 119 of the ink tank 100. That is, the outer shape of the front portion of the bottle tube 96 is circular and the outer shape of the rear portion of the bottle tube 96 is rectangular. In other words, the bottle tube 96 has an outer shape in which the front side of the rectangle is convex in an arc shape. The cross-section of the inner space of the bottle tube 96 has a circular shape. Since the rear portion of the outer shape of the bottle tube 96 is rectangular, the thickness of the bottle tube 96 at the corner portions of the bottle tube 96 having a rectangle shape are greater than the thickness of the front portion of the bottle tube 96. As a result, the bottle tube 96 is less likely to be deformed rearward. The bottle tube 96 is an example of the nozzle.

As illustrated in FIG. 8, the opening 95 is located rearward of the center C1 of the protrusion 94. The outer peripheral surface of the protrusion 94 is not rotationally symmetrical about a center C2 of the opening 95. The opening 96A of the bottle tube 96 is located frontward of the center C1 of the protrusion 94. The opening 96A is located frontward of the opening 95. The bottle tube 96 extends upward from the opening 96A. The length between the opening 96A and the opening 95 in the front-rear direction is less than or equal to the one-half of the inner diameter of the opening 96A. The outer peripheral surface of the protrusion 94 is not rotationally symmetrical about a center C3 of the opening 96A. The opening 95 is an example of the air inlet. The opening 96A is an example of the liquid supply port.

As illustrated in FIG. 10, a lip 108 and a lip 109 are positioned on the lower surface of the base portion 86. The lip 108 and the lip 109 are portions which constitute a seal for sealing. The lip 108 and the lip 109 are protruding portions which are elastically deformable. The lip 108 extends downward in the up-down direction from the lower surface of the base portion 86. The lip 108 has an annular shape in which a first length of the lip 108 in the front-rear direction is longer than a second length of the lip 108 in the left-right direction. Specifically, the lip 108 has an oblong shape, in which the ends of the lip 108 in the front-rear direction are curved and the ends of the lip 108 in the left-right direction extends linearly in the front-rear direction. The opening 95 and the opening 96A are located inward of the lip 108. In other words, the lip 108 surrounds the opening 95 and the opening 96A. The lip 108 elastically deforms by the entire periphery of the lip 108 contacting the valve 161, thereby forming a liquid-tight seal with the valve 161.

The lip 109 extends downward in the up-down direction from the lower surface of the protrusion 86B at the periphery of the opening 96A. The lip 109 is positioned inward of the lip 108. The lip 109 has a circle shape. The lower end of the lip 109 is positioned above the lower end of the lip 108. The lip 109 elastically deforms by contacting the valve 161, thereby forming a liquid-tight seal with the valve 161.

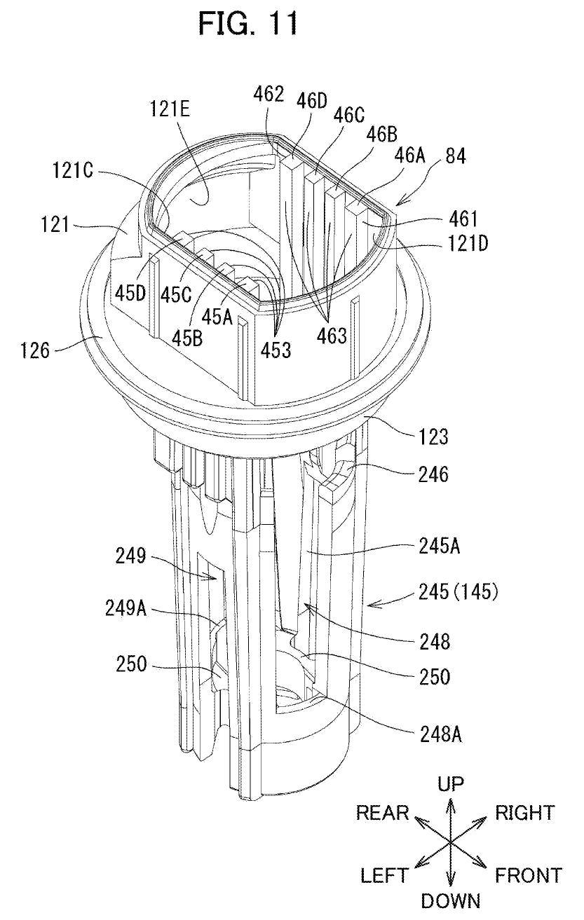

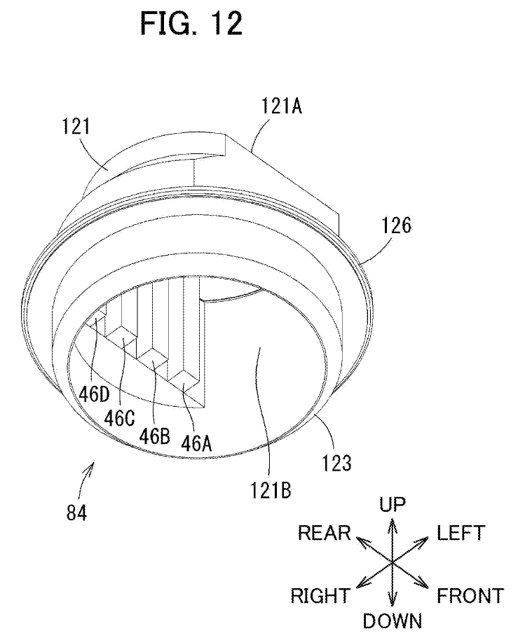

As illustrated in FIGS. 11, 12, and 14 the support member 84 is positioned inside the valve accommodating space 148. The support member 84 has an upper portion 121, a flange 126, and a lower portion 123. Note that a support member 245 described later is omitted in FIG. 12.

The upper portion 121 has a cylindrical body having an oblong shape when viewed from above. The upper portion 121 is press-fitted in the inner peripheral surface of the protrusion 94 of the bottle cap 82. Hence, the support member 84 is fixed to the inner surface of the bottle cap 82. An upper end surface 121A of the upper portion 121 is in contact with the lower surface of the rubber 83 at the position outward of the lip 108. The shape of the upper end surface 121A is approximately the same as the outer shape of the base portion 86 of the rubber 83. Also, the shape of the upper end surface 121A is approximately the same as the oblong shape of the lip 108. The rubber 83 is sandwiched in the up-down direction between the upper wall 97 of the protrusion 94 of the bottle cap 82 and the upper portion 121 of the support member 84. The lip 108 of the rubber 83 is positioned inward of the upper portion 121 and is in contact with the upper portion 121. In other words, the upper portion 121 is in contact with the outer portion of the lip 108.

The inner peripheral surface of the upper portion 121 has a front inner curved surface 121B, a left inner flat surface 121C, a right inner flat surface 121D, and a rear inner curved surface 121E. The front inner curved surface 121B is convex toward the front. The left inner flat surface 121C is connected to the left end of the front inner curved surface 121B. The right inner flat surface 121D is connected to the right end of the front inner curved surface 121B. The rear inner curved surface 121E is convex toward the rear. The rear inner curved surface 121E connects the rear end of the left inner flat surface 121C and the rear end of the right inner flat surface 121D to each other. The rear inner curved surface 121E is sloped relative to the up-down direction such that the rear inner curved surface 121E extends rearward as the rear inner curved surface 121E extends downward. Hence, the inner space of the upper portion 121 expands rearward as the inner space of the upper portion 121 approaches the lower.

The upper portion 121 has four left protruding portions 45A, 45B, 45C, and 45D, and four right protruding portions 46A, 46B, 46C, and 46D. Each of the left protruding portions 45A, 45B, 45C, and 45D is positioned at the left inner flat surface 121C. The four left protruding portions 45A, 45B, 45C, and 45Dare arranged at intervals in the front-rear direction. Each of the left protruding portions 45A, 45B, 45C, and 45D extends in the up-down direction from the upper end portion of the upper portion 121 to the lower end portion of the upper portion 121. Each of the left protruding portions 45A, 45B, 45C, and 45D has a quadrangular prism shape. Each of the left protruding portions 45A, 45B, 45C, and 45D has a front surface 451 facing frontward, a rear surface 452 facing rearward, and a right surface 453 facing rightward.

The four right protruding portions 46A, 46B, 46C, and 46D are positioned at the right inner flat surface 121D. The four right protruding portions 46A, 46B, 46C, and 46D are arranged at intervals in the front-rear direction. Each of the right protruding portions 46A, 46B, 46C, and 46D extends in the up-down direction from the upper end portion of the upper portion 121 to the lower end portion of the upper portion 121. Each of the four right protruding portions 46A, 46B, 46C, and 46D has a quadrangular prism shape. Each of the four right protruding portions 46A, 46B, 46C, and 46D has a front surface 461 facing frontward, a rear surface 462 facing rearward, a left surface 463 facing leftward.

The flange 126 is a circular plate extending outward from the lower end of the outer peripheral surface of the upper portion 121. The flange 126 does not protrude to the inner space of the upper portion 121. The outer diameter of the flange 126 is greater than the inner diameter of the opening portion 87 of the bottle main body 81. The outer diameter of the flange 126 is smaller than the inner diameter of the side wall 93 of the bottle cap 82. The flange 126 is in contact with the upper surface of the opening portion 87 of the bottle main body 81. The flange 126 is sandwiched by the upper surface of the opening portion 87 of the bottle main body 81 and the bottom wall 92 of the bottle cap 82 in the up-down direction. Since the upper portion 121 of the support member 84 is press-fitted in an inner peripheral surface of the protrusion 94 of the bottle cap 82, and the flange 126 of the support member 84 is sandwiched between the upper surface of the opening 87 of the bottle main body 81 and the bottom wall 92 of the bottle cap 82, the support member 84 is fixed relative to the bottle main body 81 and the bottle cap 82.

The lower portion 123 has a cylindrical shape extending downward from the flange 126. The outer diameter of the lower portion 123 is smaller than the inner diameter of the side wall 93 of the bottle cap 82. The outer diameter of the lower portion 123 is slightly smaller than the inner diameter of the opening portion 87 of the bottle main body 81.

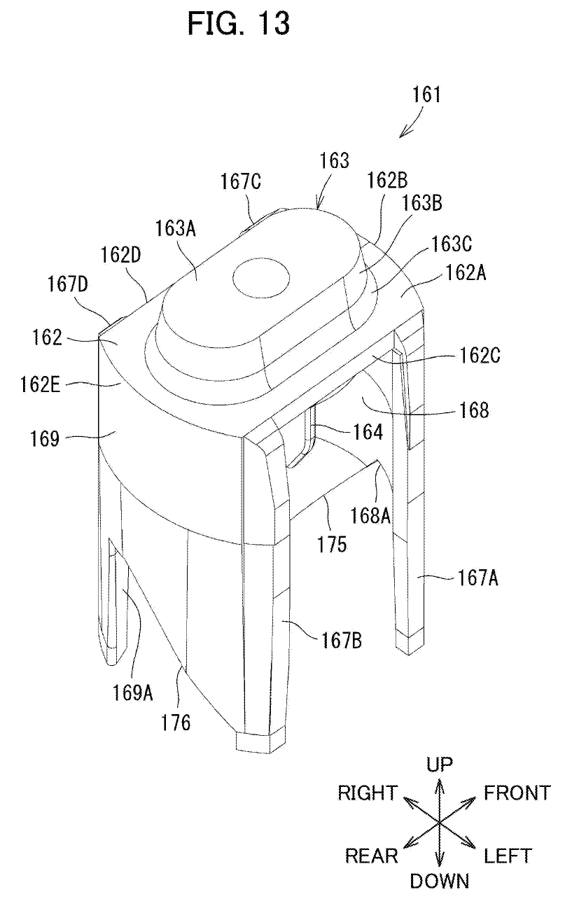

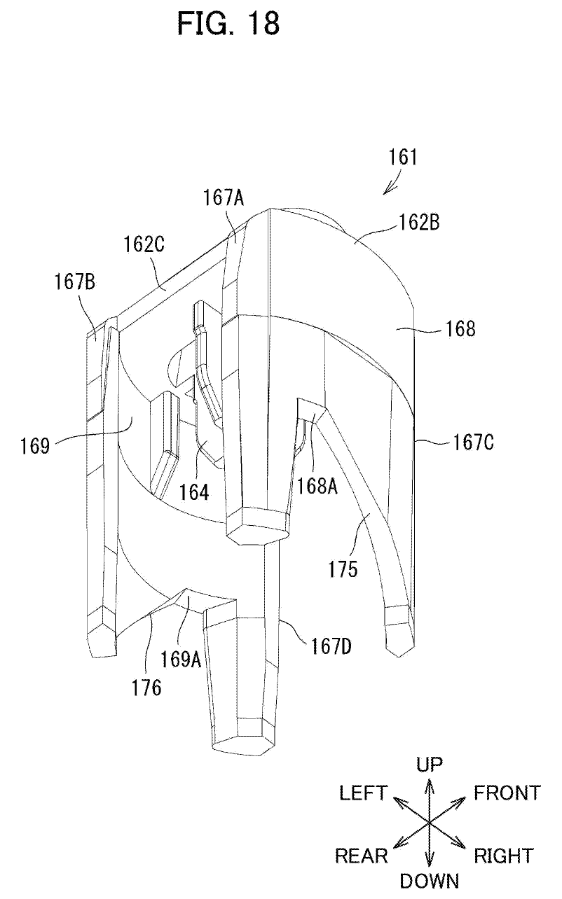

As illustrated in FIGS. 13, 14, and 18 the valve 161 is positioned inside the valve accommodating space 148. The valve 161 has a flat surface portion 162, a front support wall 168, a rear support wall 169, four guide portions 167A, 167B, 167C, and 167D, a protruding portion 163, and a spring seat 164.

The flat surface portion 162 is configured to be positioned inward of the upper portion 121 of the support member 84. In a state where the flat surface portion 162 is positioned inward of the upper portion 121 of the support member 84, the valve 161 is guided by the support member 84, and therefore the valve 161 is movable in the up-down direction. The up-down direction is an example of the movement direction.

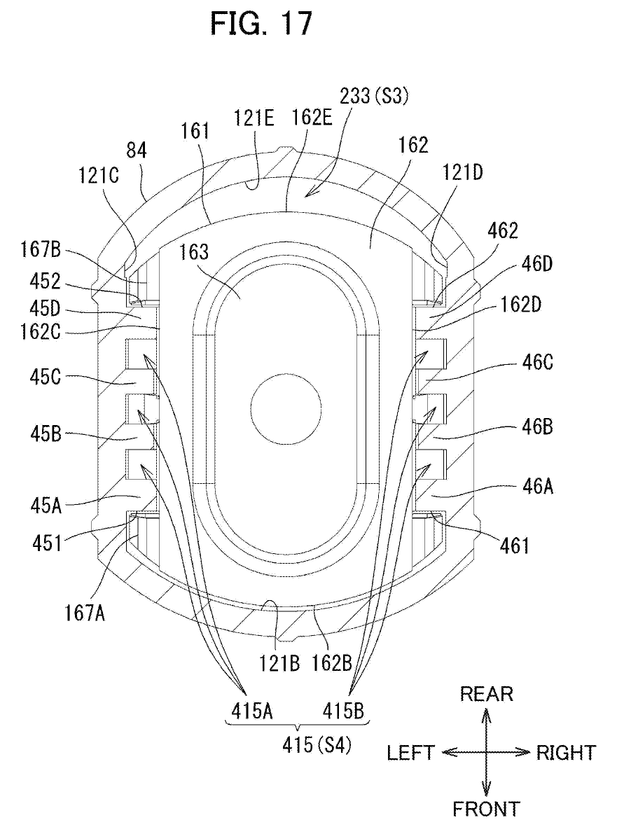

The flat surface portion 162 has a plate shape extending in the front-rear direction and the left-right direction. The outer peripheral surface of the flat surface portion 162 has an oblong shape. Specifically, the outer peripheral surface of the flat surface portion 162 has a front outer curved surface 162B convex toward the front, a left outer flat surface 162C facing leftward, a right outer flat surface 162D facing rightward, and a rear outer curved surface 162E convex toward the rear. As illustrated in FIGS. 11 and 17, the left outer flat surface 162C of the flat surface portion 162 is in contact with the right surface 453 of each of the four left protruding portions 45A, 45B, 45C, and 45D. The right outer flat surface 162D is in contact with the left surface 463 of each of the four right protruding portions 46A, 46B, 46C, and 46D. An upper surface 162A of the flat surface portion 162 is a flat surface. The center axis B3 passing through the center of the flat surface portion 162 is offset frontward relative to the center axis B2 of the opening portion 87. The center axis B3 passing through the center of the flat surface portion 162 is offset frontward relative to the center axis B1 of the protrusion 94.

The front support wall 168 extends downward from the front-end portion of the flat surface portion 162. The front support wall 168 has a substantially flat plate shape extending in the up-down direction and the left-right direction. The front surface of the front support wall 168 is a curved surface convex frontward along the front inner curved surface 121B of the support member 84. The front surface of the front support wall 168 is flush with the front outer curved surface 162B of the flat surface portion 162. The front support wall 168 has a front recessed portion 168A recessed upward from the lower end of the front support wall 168. The front recessed portion 168A has a front guide surface 175 which is sloped relative to the up-down direction such that front guide surface 175 extends leftward as the front guide surface 175 approaches upward from the right end portion of the lower end of the front support wall 168. The left end of the front guide surface 175 is located leftward of the center in the left-right direction of the front support wall 168. The left end of the front guide surface 175 is located at substantially the center in the up-down direction of the front support wall 168.

The rear support wall 169 extends downward from the rear end portion of the flat surface portion 162. The rear support wall 169 has a substantially flat plate shape extending in the up-down direction and the left-right direction. The rear surface of the rear support wall 169 is a curved surface convex rearward along the rear inner curved surface 121E of the support member 84. The rear surface of the rear support wall 169 is flush with the rear outer curved surface 162E of the flat surface portion 162. The rear support wall 169 has a rear recessed portion 169A recessed upward from the lower end of the rear support wall 169. The rear recessed portion 169A has a rear guide surface 176 which is sloped relative to the up-down direction such that the rear guide surface 176 extends rightward as the rear guide surface 176 approaches the upper from the left end portion of the lower end of the rear support wall 169. The right end of the rear guide surface 176 is located rightward of the center in the left-right direction of the rear support wall 169. The right end of the rear guide surface 176 is located at substantially the center in the up-down direction of the rear support wall 169.

As illustrated in FIGS. 13, 17, and 18 the four guide portions 167A, 167B, 167C, and 167D protrudes from at the outer peripheral surface of the flat surface portion 162. The guide portion 167A extends downward in the up-down direction from the front-end portion of the left outer flat surface 162C of the outer peripheral surface of the flat surface portion 162 to the lower end of the front support wall 168. The guide portion 167A is in contact with the front surface 451 of the left protruding portion 45A. The guide portion 167B extends downward in the up-down direction from the rear end portion of the left outer flat surface 162C of the outer peripheral surface of the flat surface portion 162 to the lower end of the rear support wall 169. The guide portion 167B is in contact with the rear surface 452 of the left protruding portion 45D. The guide portion 167C extends downward in the up-down direction from the front-end portion of the right outer flat surface 162D of the outer peripheral surface of the flat surface portion 162 to the lower end of the front support wall 168. The guide portion 167C is in contact with the front surface 461 of the right protruding portion 46A. The guide portion 167D extends downward in the up-down direction from the rear end portion of the right outer flat surface 162D of the outer peripheral surface of the flat surface portion 162 to the lower end of the rear support wall 169. The guide portion 167D is in contact with the rear surface 462 of the right protruding portion 46D.

The protruding portion 163 is positioned inward of the outer peripheral surface of the flat surface portion 162. The upper surface 162A is located around the protruding portion 163. The protruding portion 163 protrudes upward from the upper surface 162A toward the opening 95 and the opening 96A. The protruding portion 163 has an upwardly tapered shape such that the cross-sectional area of the protruding portion 163 taken along the front-rear direction and the left-right direction gradually decreases. The protruding portion 163 has an upper surface 163A, a side surface 163B, and a curved surface 163C.

The upper surface 163A of the protruding portion 163 is smaller than the upper surface 162A of the flat surface portion 162. The upper surface 163A has an oblong shape, which is similar to the outer shape of the lip 108 of the rubber 83. The outer shape of the upper surface 163A is smaller than the outer shape of the inner surface of the lip 108. The upper surface 163A is configured to contact the lip 109 of the rubber 83. The side surface 163B extends downward from the outer edge of the upper surface 163A. The curved surface 163C connects the lower end of the side surface 163B and the upper surface 162A of the flat surface portion 162. The curved surface 163C faces diagonally upward and is recessed downward. The protruding portion 163 is configured to be positioned inward of the lip 108 of the rubber 83. The curved surface 163C is configured to contact the lip 108 of the rubber 83. In a state where the curved surface 163C is in contact with the lip 108, the upper surface 163A is configured to contact the lip 109 of the rubber 83.

The spring seat 164 is positioned at the lower surface of the flat surface portion 162. The coil spring 165 which is expandable and contractible in the up-down direction is disposed at the spring seat 164. The upper end of the coil spring 165 is in contact with the lower surface of the flat surface portion 162. The coil spring 165 urges the valve 161 upward. The coil spring 165 is an example of the first spring. The coil spring 165 is an example of the elastic member.

The valve 161 is movable between the closed position and the open position in the up-down direction. The movement of the valve 161 between the closed position and the open position is guided by the support member 84. As illustrated in FIG. 14, when the valve 161 is at the closed position, the lip 108 is in contact with the curved surface 163C of the protruding portion 163. As a result, ink does not enter into the inner space of the lip 108 of the rubber 83. Also, since the protruding portion 163 is positioned inward of the lip 108 when the valve 161 is at the closed position, the likelihood that the lip 108 is displaced inward can be reduced. Note that the upper portion 121 of the support member 84 is positioned outward of the lip 108, the likelihood that the lip 108 is displaced outward can be also reduced.

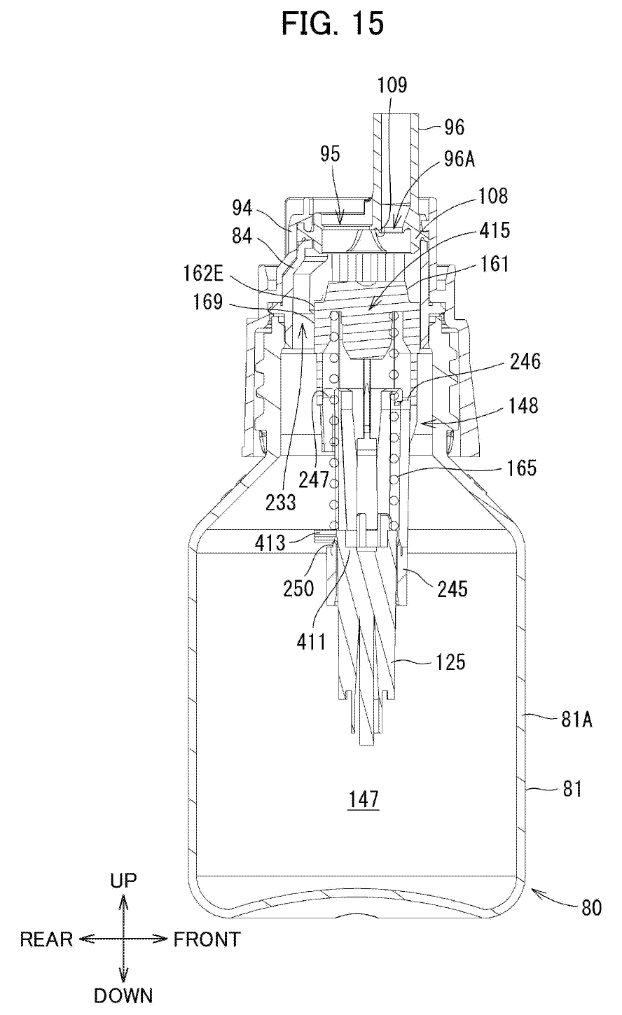

As illustrated in FIG. 15, the open position of the valve 161 is a position where the valve 161 moves downward against the urging force of the coil spring 165. When the valve 161 is at the open position, the protruding portion 163 of the valve 161 is positioned below the lower end of the lip 108 of the rubber 83. Hence, the upper surface 163A of the protruding portion 163 is apart from the lip 109, and the curved surface 163C of the protruding portion 163 is apart from the lip 108.

As illustrated in FIG. 17, the valve 161 at the open position and the support member 84 define an air flow passage 233 and an ink flow passage 415. The air flow passage 233 is defined by the rear inner curved surface 121E, the left inner flat surface 121C, and the right inner flat surface 121D of the support member 84, the rear outer curved surface 162E of the flat surface portion 162, and the rear surface of the rear support wall 169. The air flow passage 233 provides communication between the ink storage chamber 147 and the opening 95. Since the protruding portion 163 is positioned on the upper surface 162A of the flat surface portion 162, the air flow passage 233 at the protruding portion 163 extends further in the front-rear direction than the air flow passage 233 at both the flat surface portion 162 and the rear support wall 169 extends in the front-rear direction.

The ink flow passage 415 includes left ink flow passages 415A and right ink flow passages 415B. The left ink flow passages 415A are defined by the left outer flat surface 162C of the flat surface portion 162 and the four left protruding portions 45A, 45B, 45C, and 45D. In other words, the three left ink flow passages 415A are provided leftward of the valve 161. The three left ink flow passages 415A are arranged at intervals in the front-rear direction. The right ink flow passages 415B are defined by the right outer flat surface 162D of the flat surface portion 162 and the four right protruding portions 46A, 46B, 46C, and 46D. In other words, the three right ink flow passages 415B are provided rightward of the valve 161. The three right ink flow passages 415B are arranged at intervals in the front-rear direction. Each left ink flow passage 415A provides communication between the ink storage chamber 147 and the opening 96A. Each right ink flow passage 415B provides communication between the ink storage chamber 147 and the opening 96A. Since the protruding portion 163 is positioned on the upper surface 162A of the flat surface portion 162, each left ink flow passage 415A at the protruding portion 163 extends further in the left-right direction than the left ink flow passage 415A at the flat surface portion 162 extends in the left-right direction. Also, since the protruding portion 163 is positioned on the upper surface 162A of the flat surface portion 162, each left ink flow passage 415A at the protruding portion 163 extends further in the left-right direction than the corresponding left ink flow passage 415A at the flat surface portion 162 extends in the left-right direction, and each right ink flow passage 415B at the protruding portion 163 extends further in the left-right direction than the corresponding right ink flow passage 415B at the flat surface portion 162 extends in the left-right direction.

The air flow passage 233 is larger than the ink flow passage 415. Specifically, an area S3 of the air flow passage 233 is larger than an area S4 which is the sum of the areas of the left ink flow passages 415A and the areas of the right ink flow passages 415B. The area S3 of the air flow passage 233 is a cross-sectional area taken along a horizontal plane extending in the horizontal direction, the horizontal plane having the flat surface portion 162 positioned at the open position. The area S4 is the sum of the cross-sectional areas of the left ink flow passages 415A and the cross-sectional areas of the right ink flow passages 415B. The cross-sectional areas of the left ink flow passages 415A are taken along a horizontal plane extending in the horizontal direction, the horizontal plane having the flat surface portion 162 positioned at the open position. The cross-sectional areas of the right ink flow passages 415B are taken along a horizontal plane extending in the horizontal direction, the horizontal plane having the flat surface portion 162 positioned at the open position.

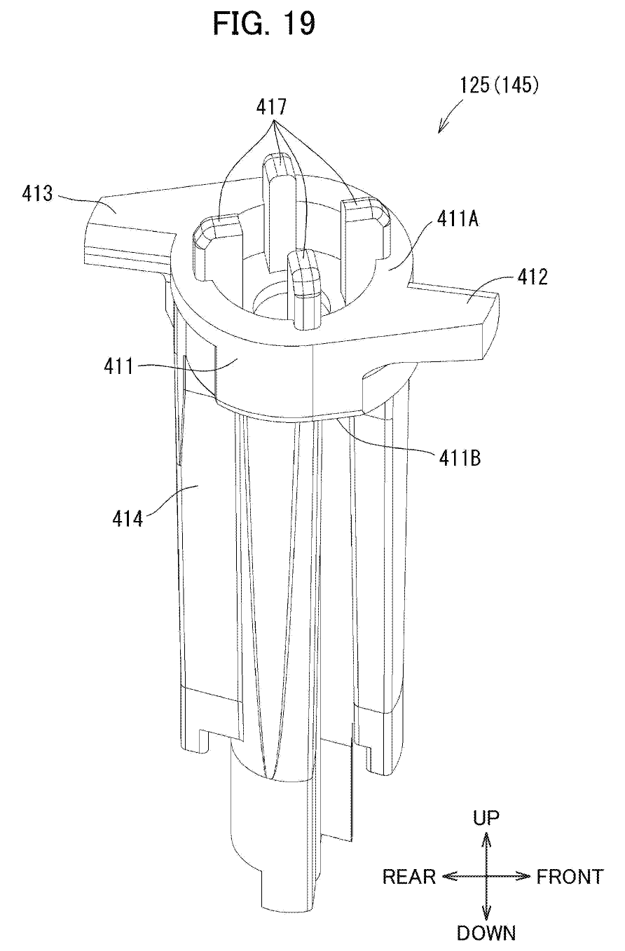

As illustrated in FIGS. 11, 14, and 19 the switching mechanism 145 is positioned below the support member 84 inside the valve accommodating space 148. The switching mechanism 145 is configured to switch the urging force with which the coil spring 165 urges the valve 161 between a first urging force and a second urging force. The second urging force is weaker than the first urging force. Specifically, the switching mechanism 145 includes the support member 245 and a spring seat 125 supported by the support member 245. The switching mechanism 145 has a cylindrical shape and extends in the up-down direction.

The support member 245 is a substantially cylindrical body extending in the up-down direction from the inner space of the lower portion 123 of the support member 84 to the position below the lower portion 123. The upper end of the support member 245 is connected to the lower end of the upper portion 121 of the support member 84. Since the support member 84 is fixed to the bottle main body 81 and the bottle cap 82, the support member 245 connected to the support member 84 is also fixed to the bottle main body 81 and the bottle cap 82. The support member 245 has a front contact surface 246, a rear contact surface 247, a front guide slit 248, a rear guide slit 249, and a lower contact surface 250.

The front contact surface 246 is located at the front-end portion of the support member 245. The front contact surface 246 is located above the center in the up-down direction of the support member 245. The front contact surface 246 is a surface facing upward. The front contact surface 246 extends through the front-end portion of the support member 245 in the front-rear direction. The front contact surface 246 is sloped relative to the left-right direction such that the front contact surface 246 extend upward as the front contact surface 246 approaches the right. The front contact surface 246 is an example of a first holding portion.

The rear contact surface 247 is located at the rear end portion of the support member 245. The position of the rear contact surface 247 coincides with the position of the front contact surface 246 in the up-down direction. The rear contact surface 247 is a surface facing upward. The rear contact surface 247 extends through the rear end portion of the support member 245 in the front-rear direction. The rear contact surface 247 is sloped relative to the left-right direction such that the rear contact surface 247 extend upward as the rear contact surface 247 approaches the left. The rear contact surface 247 is an example of a fifth holding portion.

The front guide slit 248 extends downward from a portion adjacent to the left portion of the front contact surface 246 about the center axis B4 of the support member 245. The center axis B4 of the support member 245 coincides with the center axis B3 of the valve 161. The front guide slit 248 is a gap formed by the front guide slit 248 extending through the front-end portion of the support member 245 in the front-rear direction. A lower end 248A of the front guide slit 248 is located below the center in the up-down direction of the support member 245. The front guide slit 248 is an example of a first guide slit.

The rear guide slit 249 extends downward from a portion adjacent to the right portion of the rear contact surface 247 about the center axis B4. The rear guide slit 249 is a gap formed by the rear guide slit 249 extending through the rear end portion of the support member 245 in the front-rear direction. A lower end 249A of the rear guide slit 249 is located below the center in the up-down direction of the support member 245. The rear guide slit 249 is an example of a second guide slit.

The lower contact surface 250 is located below the lower end 248A of the front guide slit 248 and the lower end 249A of the rear guide slit 249. The lower contact surface 250 is a surface facing upward and protruding inward in an annular shape from an inner peripheral surface 245A of the support member 245. The lower contact surface 250 is an example of a second holding portion.

The spring seat 125 is positioned inside the inner space of the support member 245. The spring seat 125 is supported by the inner peripheral surface 245A of the support member 245 such that the spring seat 125 is movable in the up-down direction and rotatable about the center axis B4. The spring seat 125 has a support body 411, a front guide piece 412, a rear guide piece 413, a columnar portion 414, and four protruding pieces 417. The spring seat 125 is an example of a first spring seat.

The support body 411 has an annular shape. The outer peripheral surface of the support body 411 corresponds to the inner peripheral surface 245A of the support member 245. The outer diameter of the support body 411 is slightly smaller than the inner diameter of the support member 245. Accordingly, the support body 411 is movable in the up-down direction inside the inner space of the support member 245 and is rotatable about the center axis B4 inside the inner space of the support member 245. The four protruding pieces 417 are arranged in the circumferential direction of the support body 411 at equal intervals at the inner peripheral surface of the support body 411. Each protruding piece 417 protrudes upward of the upper surface 411A of the support body 411. In a state where the protruding pieces 417 are in contact with the inner portion of the coil spring 165, the lower end of the coil spring 165 is in contact with the upper surface 411A of the support body 411. Hence, the support body 411 supports the lower end of the coil spring 165. Since the lower surface 411B of the support body 411 contacts the lower contact surface 250, the spring seat 125 is held to ensure that the spring seat 125 does not drop out from the inner space of the support member 245. When the lower surface 411B of the support body 411 is in contact with the lower contact surface 250, the coil spring 165 urges the valve 161 to the closed position with the second urging force. The position where the lower surface 411B of the support body 411 contacts the lower contact surface 250 is an example of a second support position.

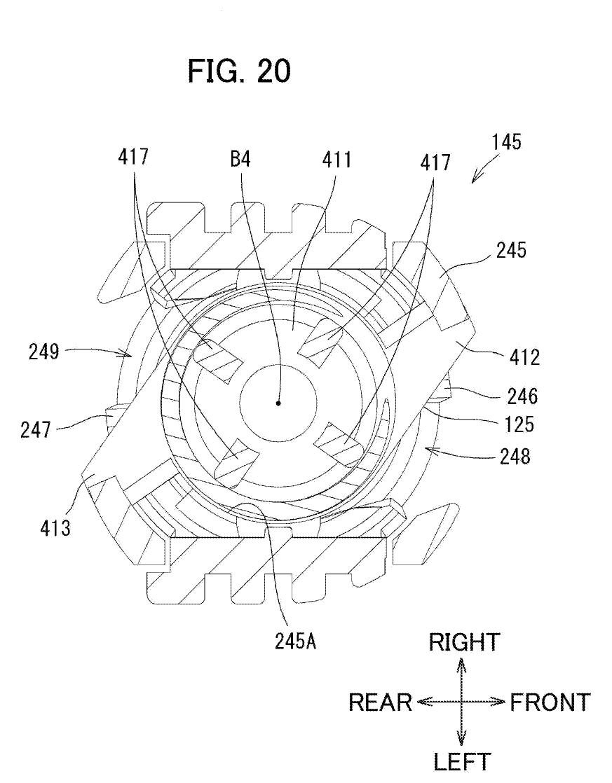

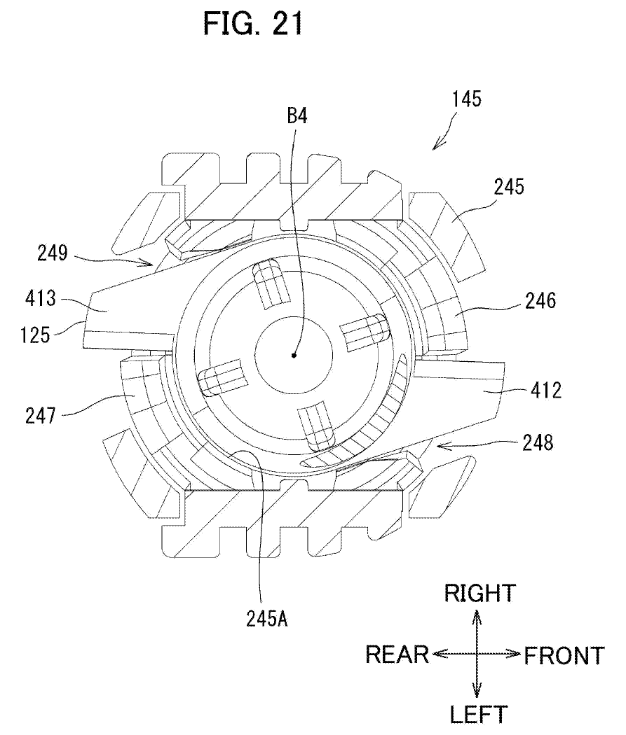

As illustrated in FIGS. 20 and 21, the front guide piece 412 protrudes frontward from the front-end portion of the outer peripheral surface of the support body 411. The front guide piece 412 is a flat plate extending in the front-rear direction and the left-right direction. The front guide piece 412 is rotatable about the center axis B4 between a position in contact with the front contact surface 246 and a position facing the front guide slit 248 in the up-down direction. The front guide piece 412 which is at the position in contact with the front contact surface 246 faces the right end portion of the front guide surface 175 of the valve 161 in the up-down direction. When the front guide piece 412 is in contact with the front contact surface 246, the coil spring 165 is compressed more in the up-down direction than when the lower surface 411B of the support body 411 is in contact with the lower contact surface 250. As a result, the coil spring 165 urges the valve 161 to the closed position with the first urging force, which is stronger than the second urging force. The position where the front guide piece 412 contacts the front contact surface 246 is an example of a first support position.

The front guide piece 412 is movable in the up-down direction inside the front guide slit 248. The front guide piece 412 is movable downward from the upper end of the front guide slit 248 to the position where the lower surface 411B of the support body 411 contacts the lower contact surface 250. In a state where the lower surface 411B of the support body 411 is in contact with the lower contact surface 250, the lower surface of the front guide piece 412 is positioned slightly above the lower end 248A of the front guide slit 248. The front guide piece 412 is an example of a first guide piece.

The rear guide piece 413 is positioned at a position point-symmetrical to the front guide piece 412 with respect to the center axis B4. The rear guide piece 413 protrudes rearward from the rear end portion of the outer peripheral surface of the support body 411. The rear guide piece 413 is a flat plate extending in the front-rear direction and the left-right direction. The rear guide piece 413 is rotatable about the center axis B4 between a position in contact with the rear contact surface 247 and a position facing the rear guide slit 249 in the up-down direction. The rear guide piece 413 at the position in contact with the rear contact surface 247, faces the left end portion of the rear guide surface 176 of the valve 161 in the up-down direction. When the rear guide piece 413 is in contact with the rear contact surface 247, the coil spring 165 is compressed more in the up-down direction than when the lower surface 411B of the support body 411 is in contact with the lower contact surface 250. As a result, the coil spring 165 urges the valve 161 to the closed position with the first urging force, which is stronger than the second urging force. The position where the rear guide piece 413 contacts the rear contact surface 247 is an example of a first support position.

The rear guide piece 413 is movable in the up-down direction inside the rear guide slit 249. The rear guide piece 413 is movable downward from the upper end of the rear guide slit 249 to the position where the lower surface 411B of the support body 411 contacts the lower contact surface 250. In a state where the lower surface 411B of the support body 411 is in contact with the lower contact surface 250, the lower surface of the rear guide piece 413 is located slightly above the lower end of the rear guide slit 249. The rear guide piece 413 is an example of a second guide piece.

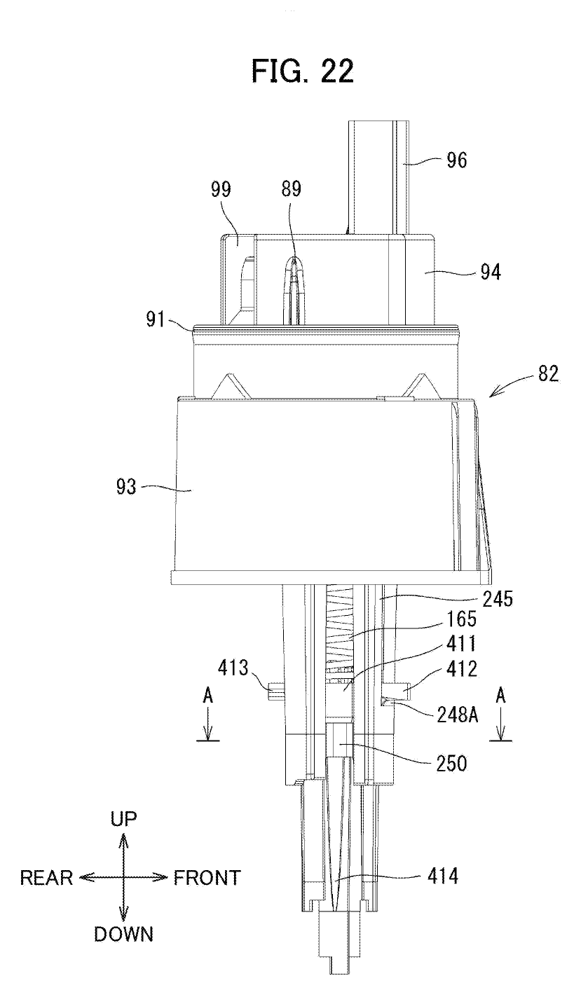

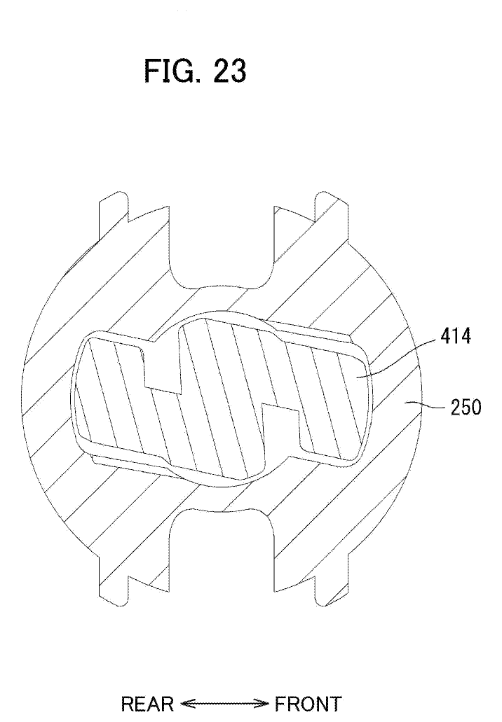

The columnar portion 414 has a columnar shape extending downward in the up-down direction from the lower surface 411B of the support body 411. As illustrated in FIG. 23, the columnar portion 414 is movable in the up-down direction inside the lower contact surface 250. As illustrated in FIGS. 15 and 22, in a state where the support body 411 is in contact with the lower contact surface 250, the columnar portion 414 significantly protrudes downward from the lower end of the support member 245. As illustrated in FIG. 14, in a state where the front guide piece 412 is in contact with the front contact surface 246, the lower end of the columnar portion 414 coincides with the lower end of the support member 245 in the up-down direction.

Connection Between the Ink Bottle 80 and the Ink Tank 100

In an initial state of the ink bottle 80, the front guide piece 412 is in contact with the front contact surface 246. The rear guide piece 413 is in contact with the rear contact surface 247. The coil spring 165 urges the valve 161 to the closed position with the first urging force.

Firstly, since a user directly visually recognizes ink stored inside the ink bottle 80 from the outside of the main body container 81A or the user checks a color or a name of color indicated by a label on the ink bottle 80, the user identifies a color of ink storing in the inside of the ink bottle 80. Also, since the user checks colors or names of colors indicated by labels each of which provided on the portion of the front wall 101 of the ink tank 100 corresponding to the corresponding one of the ink chambers 111, and colors or names of colors indicated by labels each of which provided on the portion of the tank cover 110 corresponding to the corresponding one of the ink chambers 111, the user identifies a color to be supplied to the corresponding one of the ink chambers 111. Accordingly, the user identifies the corresponding one of the four through-holes 72 of the tank cover 110 into which the corresponding ink bottle 80 is inserted. Next, the user identifies an orientation in which the protrusion 94 of the ink bottle 80 is inserted into the corresponding through-hole 72 of the tank cover 110. At this time, since the outer curved surface 94A and the rear outer flat surface 94D are positioned such that the opening 95 and the bottle tube 96 are positioned between the outer curved surface 94A and the rear outer flat surface 94D in the front-rear direction, the user can identify easily the orientation in which the protrusion 94 is inserted into the corresponding through-hole 72.

For example, the user inserts the protrusion 94 into the leftmost through-hole 72. At this time, the key member 99 is inserted into the key groove 74 of the leftmost through-hole 72. At this time, in a case where the user mistakenly attempts to insert the protrusion 94 into the through-hole 72 which is the second from the left, the key member 99 cannot be inserted into the key groove 74. As a result, the likelihood that the ink bottle 80 is connected to an incorrect position can be reduced.

Upon the key member 99 being inserted into the corresponding key groove 74, the bottle tube 96 is inserted in the corresponding communication port 119 of the ink tank 100 and the corresponding tank tube 115 is inserted in the opening 95 of the ink bottle 80. At this time, the valve 161 is pressed frontward and upward by the corresponding tank tube 115, and accordingly the valve 161 moves from the closed positioned toward the open position against an urging force of the coil spring 165. As a result, the ink bottle 80 is connected to the ink tank 100. At this time, a force in a direction in which the protrusion 94 is pushed out from the corresponding through-hole 72 acts on the ink bottle 80 due to the urging force of the coil spring 165. However, the likelihood that the protrusion 94 is pushed out from the corresponding through-hole 72 can be reduced by a frictional force generated between the ribs 89 and the inner peripheral surface of the corresponding through-hole 72.

In a process where the valve 161 moves from the closed position to the open position, the front guide surface 175 of the front recessed portion 168A of the valve 161 contacts the front guide piece 412 from above. Simultaneously, the rear guide surface 176 of the rear recessed portion 169A of the valve 161 contacts the rear guide piece 413. As the front recessed portion 168A moves downward, the front recessed portion 168A presses the front guide piece 412 to the left by utilizing the slope of the front guide surface 175. As the rear recessed portion 169A moves downward, the rear recessed portion 169A presses the rear guide piece 413 to the right by utilizing the slope of the rear guide surface 176. Accordingly, the spring seat 125 rotates to the left about the center axis B4. As a result, the front guide piece 412 moves from the position where the front guide piece 412 is held by the front contact surface 246 to the position where the front guide piece 412 faces the front guide slit 248 in the up-down direction. Simultaneously, the rear guide piece 413 moves from the position where the rear guide piece 413 is held by the rear contact surface 247 to the position where the rear guide piece 413 faces the rear guide slit 249 in the up-down direction. Then, the front guide piece 412 and the rear guide piece 413 move downward through the front guide slit 248 and the rear guide slit 249, respectively, due to gravity and the urging force of the coil spring 165. That is, the spring seat 125 moves downward relative to the support member 245. The spring seat 125 stops when the lower surface 411B of the support body 411 contacts the lower contact surface 250. At this time, since the front guide piece 412 does not contact the lower end 248A of the front guide slit 248, the likelihood that the front guide piece 412 is damaged due to the impact of the support body 411 against the lower contact surface 250 can be reduced. Simultaneously, since the rear guide piece 413 does not contact the lower end 249A of the rear guide slit 249, the likelihood that the front guide piece 413 is damaged due to the impact of the support body 411 against the lower contact surface 250 can be reduced. As described above, the spring seat 125, supporting the coil spring 165, moves downward relative to the support member 245, fixed to the bottle main body 81 and the bottle cap 82 and then the coil spring 165 extends. In other words, the urging force with which the coil spring 165 urges the valve 161 to the closed position is switched from the first urging force to the second urging force. For example, at a collection destination for the used ink bottle 80 which has finished supplying ink to the ink tank 100, an operator removes the bottle cap 82 from the bottle main body 81 and moves the spring seat 125 upward relative to the support member 245. Then the operator rotates the spring seat 125 to the right about the center axis B4. Accordingly, the coil spring 165 is compressed. That is, the operator can switch the urging force with which the coil spring 165 urges the valve 161 to the closed position from the second urging force to the first urging force. As a result, when the collected used ink bottle 80 in which ink is refilled is reused, the likelihood of ink leakage from the ink bottle 80 during transportation of the ink bottle 80 to a user can be reduced.

As illustrated in FIG. 16, in a state where the ink bottle 80 is connected to the ink tank 100: the bottle tube 96 is positioned below the corresponding tank tube 115. In the up-down direction, the position of the distal end of the bottle tube 96 coincides with the position of an upper line 181A. The base end portion 115A, at which the tank tube 115 begins to branch into two lips, coincides with an edge 108A of the lip 108 in the extending direction, in which the tank tubes 115 extend. The air flow passage 233 is positioned above the left ink flow passages 415A and the right ink flow passages 415B. The outer curved surface 94A of outer peripheral surface of the protrusion 94 is supported by the curved surface of the front-end portion of the inner peripheral surface of the corresponding through-hole 72. Further, a direction connecting the upper gap and the lower gap at the distal end of the tank tube 115 is parallel to a direction in which the right straight groove 171 and the left straight groove 172 extend.

In a state where the ink bottle 80 is connected to the ink tank 100, ink stored in the ink bottle 80 flows into the corresponding ink chamber 111 through the inner space of the bottle tube 96. Simultaneously, air flows into the ink chamber 111 from the corresponding air communication port 112, and then air flows into the inside of the ink bottle 80 through the corresponding tank tube 115. As described above, so-called gas–liquid replacement occurs, and accordingly ink inside the ink bottle 80 is supplied to the corresponding ink chamber 111. The supply of ink automatically stops when the ink level of ink inside the ink chamber 111 rises to the position of the upper line 181A.

### Technical Effects of the Embodiment

In the ink bottle 80, since a user switches the urging force with which the coil spring 165 urges the valve 161 from the first urging force to the second urging force, the user can reduce the urging force of the coil spring 165. On the other hand, the user switches the urging force with which the coil spring 165 urges the valve 161 from the second urging force to the first urging force, the user can increase the urging force of the coil spring 165. Accordingly, since a user switches the urging force of the coil spring 165 from the second urging force to the first urging force, the likelihood of ink leakage from the opening 95 and the bottle tube 96 during transportation of the multifunction peripheral 10 can be reduced, for example. On the other hand, since a user switches the urging force of the coil spring 165 from the first urging force to the second urging force, the connection of the ink bottle 80 to the ink tank 100 can be facilitated upon supply of ink and the likelihood that the ink bottle 80 connected to the ink tank 100 is pushed out by the urging force of the coil spring 165 can be reduced upon supply of ink. As described above since a user switches the urging force between the first and second urging forces, the likelihood of ink leakage from the opening 95 and the bottle tube 96 can be reduced before the connection operation of the ink bottle 80 to the ink tank 100, and the likelihood of disconnection of the ink bottle 80 from the ink tank 100 can be reduced during the connection operation of the ink bottle 80 to the ink tank 100.

In the ink bottle 80, the urging force of the coil spring 165 is switched from the first urging force to the second urging force in accordance with the movement of the valve 161 from the closed position to the open position. That is, the movement of the valve 161 from the closed position to the open position causes the urging force of the coil spring 165 to be switched from the first urging force to the second urging force. As a result, the user can quickly perform the ink supply operation from the ink bottle 80 to the ink tank 100.

In the ink bottle 80, since the spring seat 125 moves from the position where the front guide piece 412 contacts the front contact surface 246 to the position where the support body 411 contacts the lower contact surface 250, the urging force of the coil spring 165 is switched from the first urging force to the second urging force. As a result, the urging force of the coil spring 165 can be switched smoothly from the first urging force to the second urging force.

In the ink bottle 80, the support body 411 of the spring seat 125 is supported by the inner peripheral surface 245A of the support member 245 such that the support body 411 is movable in the up-down direction and is rotatable about the center axis B4. As a result, the spring seat 125 can move between the position where the front guide piece 412 contacts the front contact surface 246 and the position where the lower surface 411B of the support body 411 contacts the lower contact surface 250 while the spring seat 125 is maintained in a stable posture.

In the ink bottle 80, when the front guide piece 412 moves downward inside the front guide slit 248 by the urging force of the coil spring 165, the front guide piece 412 stops upon the support body 411 contacting the lower contact surface 250. As a result, the likelihood that the front guide piece 412 is damaged due to the impact of the support body 411 against the lower contact surface 250 can be reduced.

In the ink bottle 80, since the rear guide piece 413 is at a position point-symmetrical to the front guide piece 412 with respect to the center axis B4 of the support body 411, the front guide piece 412 and the rear guide piece 413 contact the front contact surface 246, and the rear contact surface 247, respectively, and therefore the spring seat 125 is held in a balanced manner. As a result, the front guide piece 412 and the rear guide piece 413 can rotate smoothly to the left about the center axis B4 in accordance with the movement of the valve 161 from the closed position to the open position. That is, the movement of the valve 161 from the closed position to the open position causes the front guide piece 412 and the rear guide piece 413 to rotate smoothly to the left about the center axis B4.

In the ink bottle 80, when the valve 161 moves from the closed position to the open position, the valve 161 is supported in the front-rear direction and the left-right direction by the four left protruding portions 45A to 45D and the four right protruding portions 46A to 46D of the support member 84. Accordingly, the valve 161 moves straight along the center axis B3 when the valve 161 moves from the closed position to the open position. As a result, the spring seat 125 can rotate smoothly to the left about the center axis B4 in accordance with the movement of the valve 161. That is, the movement of the valve 161 causes the spring seat 125 to rotate smoothly to the left about the center axis B4.

In the ink bottle 80, The valve 161 at the closed position closes the opening 95 and the opening 96A. Even with this configuration in which the valve 161 closes the opening 95 and the opening 96A, the likelihood of link leakage from the opening 95 and the opening 96Acan be reduced except during the connection operation of the ink bottle 80 and the ink tank 100, and the connection between the ink bottle 80 and the ink tank 100 can be reliably maintained during the supply operation of the ink bottle 80 and the ink tank 100.

In the ink bottle 80, when the corresponding tank tube 115 is inserted in the opening 95A, the portion of the valve 161 offset rearward from the center axis B3 is pressed by the corresponding tank tube 115. However, since the valve 161 is supported by the support member 84, the valve 161 moves straight along the center axis B3 when the valve 161 moves from the closed position to the open position.

In the ink bottle 80, the valve 161, the coil spring 165, and the switching mechanism 145 are mounted on the bottle cap 82, which is removably attached to the bottle main body 81. As a result, a cap unit in which the valve 161, the coil spring 165, and the switching mechanism 145 are mounted on the bottle cap 82 can be removed from the bottle main body 81 and the cap unit can be reused.

In the ink bottle 80, when ink is supplied from the ink bottle 80 to the ink tank 100 through the corresponding communication port 119 of the ink tank 100, a force acts on the ink bottle 80 in a direction in which the protrusion 94 is pushed out of the corresponding through-hole 72 of the tank cover 110 due to the urging force of the coil spring 165, urging the valve 161 to the closed position. However, the likelihood that the protrusion 94 is pushed out from the inner peripheral surface of the corresponding through-hole 72 can be reduced by the frictional force between the ribs 89 and the inner peripheral surface of the through-hole 72.

### Variations

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the ink bottle 80, since the spring seat 125 moves from the position, where the front guide piece 412 and the rear guide piece 413 contact the front contact surface 246, and the rear contact surface 247, respectively, to the position, where the support body 411 contacts the lower contact surface 250, the urging force of the coil spring 165 can be switched from the first urging force to the second urging force. However, the switching mechanism 145 is not limited to the mechanism in which the spring seat 125 moves, as long as the urging force of the coil spring 165 can be switched from the first urging force to the second urging force.

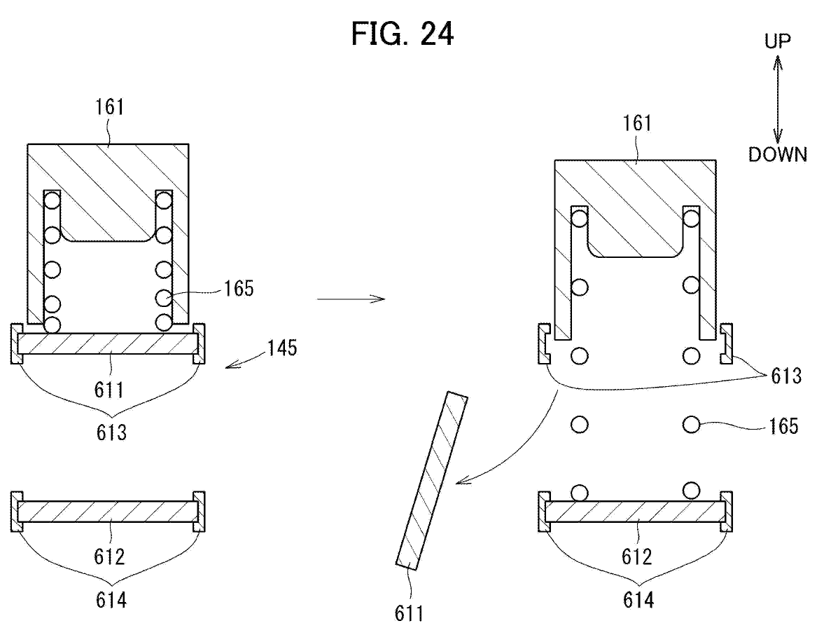

For example, as illustrated in FIG. 24, the switching mechanism 145 may include an upper spring seat 611 and a lower spring seat 612 which are configured to support the coil spring 165. The upper spring seat 611 is positioned above the lower spring seat 612. The upper spring seat 611 is at a first supporting position where the coil spring 165 urges the valve 161 to the closed position with the first urging force. The upper spring seat 611 is removably fixed to an upper holding portion 613 fixed to the bottle main body 81 or the bottle cap 82 inside the valve accommodating space 148. The lower spring seat 612 is at a second supporting position where the coil spring 165 can urge the valve 161 to the closed position with the second urging force. The lower spring seat 612 is fixed to a lower holding portion 614 fixed to the bottle main body 81 or the bottle cap 82 inside the valve accommodating space 148.

In the variation illustrated in FIG. 24, since the valve 161 moving from the closed position to the open position presses the upper spring seat 611, the upper spring seat 611 is disengaged from the upper holding portion 613. Accordingly, the coil spring 165 extends and is supported by the lower spring seat 612. As a result, the urging force of the coil spring 165 can be switched from the first urging force to the second urging force. The upper spring seat 611 is an example of the second spring seat. The upper spring seat 611 is an example of the first spring seat. The lower spring seat 612 is an example of the third spring seat. The lower spring seat 612 is an example of second spring seat. The upper holding portion 613 is an example of the third holding portion. The upper holding portion 613 is an example of first holding portion.

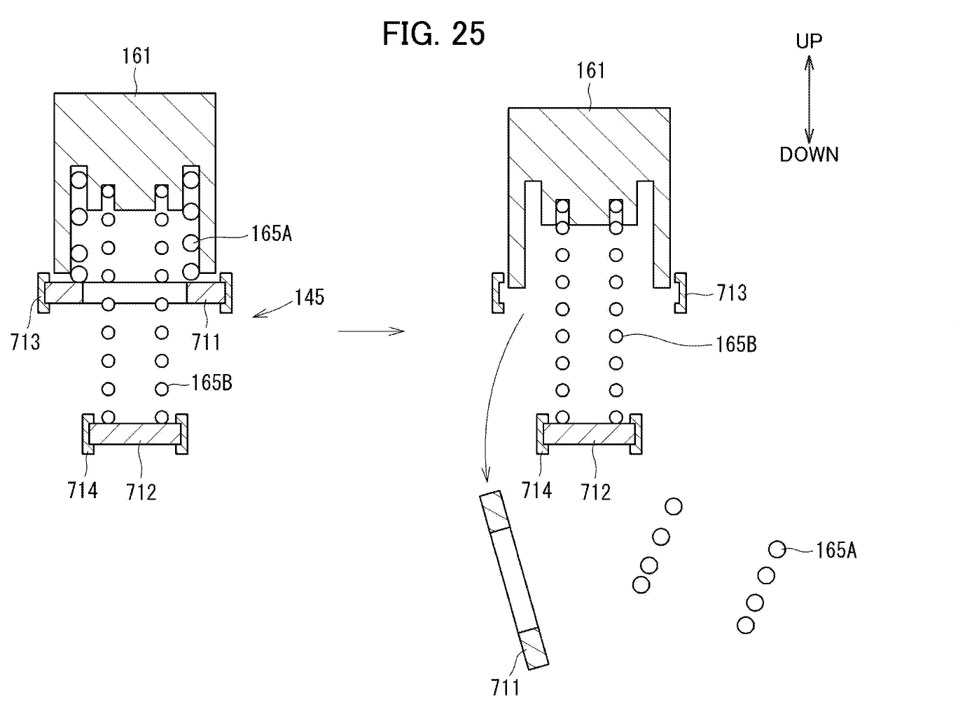

As illustrated in FIG. 25, the switching mechanism 145 may include coil springs 165A, 165B, an upper spring seat 711, and a lower spring seat 712. The lower spring seat 712 is positioned below the upper spring seat 711. The lower spring seat 712 is at the second supporting position where the coil spring 165B urges the valve 161 to the closed position with the second urging force. The lower spring seat 712 is fixed to a lower holding portion 714 fixed to the valve accommodating space 148. The upper spring seat 711 is at the first supporting position to urge the coil spring 165A with an urging force such that the first urging force is the sum of the urging force and the second urging force. That is, the upper spring seat 711 is at the first supporting position where the upper spring seat 711 supports the coil spring 165A such that the coil spring 165A urge the valve with an urging force, the first urging force being the sum of the urging force and the second urging force. The upper spring seat 711 is removably fixed to the upper holding portion 713 fixed to the valve accommodating space 148.

In the variation illustrated in FIG. 25, since the valve 161 moves from the closed position to the open position and presses the upper spring seat 711, the upper spring seat 711 is disengaged from the upper holding portion 713 and the coil spring 165A is also disengaged from the upper holding portion 713, accordingly. Hence, the valve 161 is urged just by the coil spring 165B. As a result, the urging force of the coil spring 165 can be switched from the first urging force to the second urging force. Note that, a pressing member may be provided on the valve 161. The pressing member extends downward from the center in the left-right direction of the valve 161. When the valve 161 moves from the closed position to the open position, the lower spring seat 712 may be disengaged from the lower holding portion 714 due to the pressing member pressing the lower spring seat 712. As a result, the valve 161 is urged to the closed position just by the coil spring 165A.

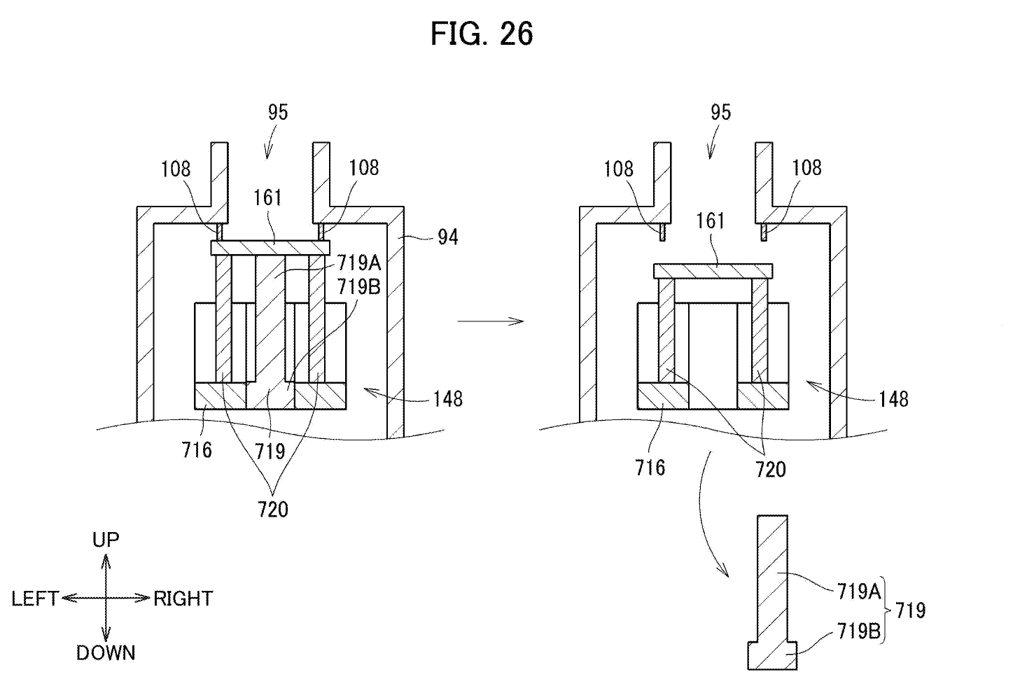

As illustrated in FIG. 26, the switching mechanism 145 may include a support portion 716, a first rubber 719, and two second rubbers 720. The support portion 716 is fixed to the bottle main body 81 or the bottle cap 82 inside the valve accommodating space 148. The support portion 716 has a substantially cylindrical shape extending in the up-down direction. The support portion 716 has two recessed portions recessed downward from the upper end of the support portion 716. The first rubber 719 is positioned inside the inner space of the support portion 716. The first rubber 719 has a columnar portion 719A extending in the up-down direction and a press-fit portion 719B positioned at the lower end portion of the columnar portion 719A. The upper end of the first rubber 719 is in contact with the lower end of the valve 161. The thickness of the press-fit portion 719B in the left-right direction is greater than the thickness of the columnar portion 719A in the left-right direction. The press-fit portion 719B is press-fitted into the inner peripheral surface of the support portion 716. The left portion of the support portion 716 is an example of a first support portion. The right portion of the support portion 716 is an example of a second support portion. Each of the first rubber 719 and second rubber 720 is example of the elastic member. The first rubber 719 is an example of the second spring seat. Each second rubber 720 is an example of the first holding portion. Note that, the support portion 716 may be divided into left and right parts as long as the press-fit portion 719B can be press-fitted in the support portion 716. The first rubber 719 urges the valve 161 to the closed position with an urging force. The sum of the urging force of the first rubber 719 and the second urging force becomes the first urging force. The two second rubbers 720 have a columnar shape extending in the up-down direction. The two second rubbers 720 are supported at the lower ends of the two recessed portions so as to urge the valve 161 to the closed position with the second urging force. Note that just one second rubber 720 may be provided as long as the valve 161 can be urged to the closed position with the second urging force. In this case, just one recessed portion may be provided.

In the variation illustrated in FIG. 26, since the valve 161 moves from the closed position to the open position and presses the first rubber 719 and the second rubber 720, the first rubber 719 and the second rubber 720 are compressed. Moreover, since the valve 161 further moves from the closed position to the open position and further presses the first rubber 719 and the second rubber 720, the first rubber 719 is removed from the inner space of the support portion 716. Accordingly, the valve 161 is urged to the closed position just by the two second rubbers 720. As a result, the urging force of the coil spring 165 is switched from the first urging force to the second urging force. Thereafter, when the ink bottle 80 is detached from the ink tank 100, the valve 161 moves to the closed position by the urging force of the two second rubbers 720. With this configuration, since the component that is detached from the inner space of the support portion 716 is just the first rubber 719, the number of components that fall off is smaller compared to the variation illustrated in FIG. 25 in which the upper spring seat 711 and the coil spring 165A are removed. As a result, the ink bottle 80 in the variation illustrated in FIG. 26 is easy to reuse.

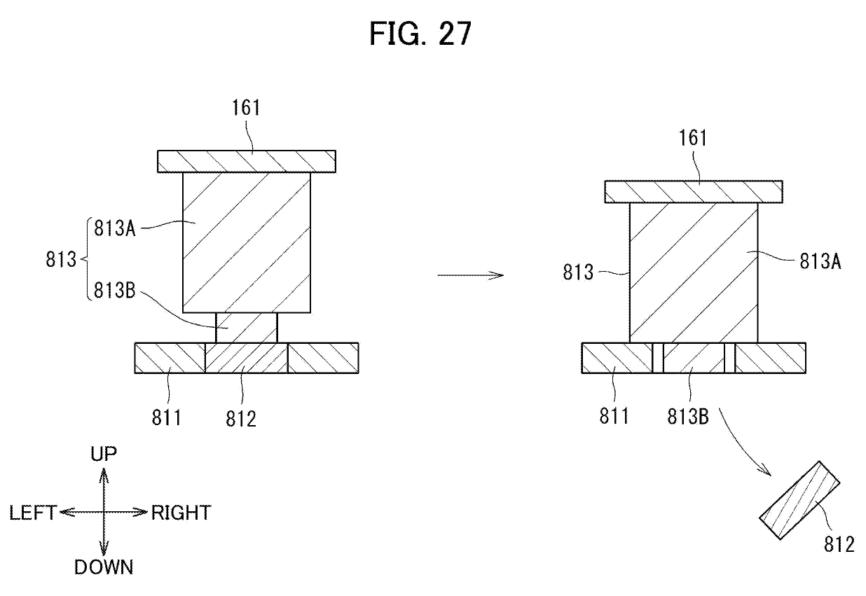

As illustrated in FIG. 27, the switching mechanism 145 may include a large spring seat 811, a small spring seat 812, and a third coil spring 813. The large spring seat 811 is fixed to the bottle main body 81 or the bottle cap 82 inside the valve accommodating space 148. The large spring seat 811 has an annular shape having a through-hole extending through the large spring seat 811 in the up-down direction. The small spring seat 812 is press-fitted in the inner peripheral surface of the large spring seat 811. The third coil spring 813 is supported by the small spring seat 812 so as to urge the valve 161 to the closed position with the first urging force. The third coil spring 813 includes a large diameter spring 813A and a small diameter spring 813B. The large diameter spring 813A is in contact with the lower end of the valve 161. The diameter of the large diameter spring 813A as the length of the large diameter spring 813A in the left-right direction is greater than the diameter of the small diameter spring 813B as the length of the small diameter spring 813B in the left-right direction. The length of the large diameter spring 813A in the left-right direction is greater than the length of the through-hole of the large spring seat 811 in the left-right direction. The small diameter spring 813B is supported by the small spring seat 812.

In the variation illustrated in FIG. 27, the third coil spring 813 includes the large diameter spring 813A and the small diameter spring 813B. In a state where the valve 161 is at the closed position, the lower end of the small diameter spring 813B is supported by the small spring seat 812. The small diameter spring 813B supported by the small spring seat 812 urges the valve 161 to the closed position with the first urging force. The valve 161 moves from the closed position to the open position and presses the third coil spring 813, the small diameter spring 813B is compressed. Moreover, the valve 161 further moves from the closed position to the open position and further presses the third coil spring 813, the small spring seat 812 is removed from the large spring seat 811. Since the small spring seat 812 is removed from the large spring seat 811, the lower end of the large diameter spring 813A is supported by the large spring seat 811. As a result, the third coil spring 813 urges the valve 161 to the closed position with the second urging force. With this configuration, since the component that is removed from the large spring seat 811 is just the small spring seat 812, the number of components that fall off is smaller compared to the variation illustrated in FIG. 25 in which the upper spring seat 711 and the coil spring 165A are removed. As a result, the ink bottle 80 in the variation illustrated in FIG. 27 is easy to reuse.

In the ink bottle 80, the urging force of the coil spring 165 is switched from the first urging force to the second urging force in accordance with the movement of the valve 161 from the closed position to the open position. That is, the movement of the valve 161 from the closed position to the open position causes the urging force of the coil spring 165 to be switched from the first urging force to the second urging force. However, the urging force may be switched from the first urging force to the second urging force by a user’s operation. For example, in the variation illustrated in FIG. 24, a user may switch the urging force of the coil spring 165 from the first urging force to the second urging force by removing the bottle cap 82 from the bottle main body 81 and then removing the upper spring seat 611 from the upper holding portion 613.

In the ink bottle 80, the spring seat 125 is supported by the inner peripheral surface 245A of the support member 245 such that the spring seat 125 is movable in the up-down direction and rotatable about the center axis B4. However, the spring seat 125 does not necessarily be supported by the inner peripheral surface 245A as long as the spring seat 125 can move from the position where the front guide piece 412 contacts the front contact surface 246 to the position where the support body 411 contacts the lower contact surface 250.

In the ink bottle 80, the rear guide piece 413 is provided at the position point-symmetrical to the front guide piece 412 with respect to the center axis B4 of the spring seat 125. However, the rear guide piece 413 is not required to be at the position point-symmetric to the front guide piece 412. The rear guide piece 413 may also be omitted.

In the ink bottle 80, the support member 84 may be omitted, as long as the valve 161 at the closed position can close the opening 95 and the opening 96A and the valve 161 at the open position can define the air flow passage 233.

In the ink bottle 80, the valve 161, the coil spring 165, and the switching mechanism 145 are mounted on the bottle cap 82. However, the valve 161, the coil spring 165, and the switching mechanism 145 may be mounted on the bottle main body 81, for example.

In the ink bottle 80, the ribs 89 are provided on the left outer flat surface 94B and the right outer flat surface 94C of the protrusion 94. However, the ribs 89 may be omitted.

In the ink bottle 80, the bottle tube 96 may be omitted. In this case, the ink tank 100 includes an ink nozzle defining the ink flow passage through which ink flows. The ink nozzle is inserted into the opening 96A.

In the ink bottle 80, the four through-holes 72 are provided on the tank cover 110. However, the four through-holes 72 may be provided on the ink tank 100.

In the ink bottle 80, the coil spring 165 is used to urge the valve 161 toward the closed position. However, any other elastic member may be used as long as the valve 161 can be urged toward the closed position.

The bottle cap 82 is detachably attached to the opening portion 87. However, the bottle cap 82 may be attached to the opening portion 87 such that the bottle cap 82 is not detachable from the opening portion 87 (i.e., the bottle cap 82 may be fixed to the opening portion 87 such that the bottle cap 82 is not detachable from the opening portion 87). The bottle cap 82 has the protrusion 94, which is offset relative to the center axis B2 of the opening portion 87. However, the bottle cap 82 does not necessarily have a portion offset relative to the center axis B2 of the opening portion 87. The bottle cap 82 and the opening portion 87 of the main body container 81A may be integrally molded product. In this case, there is no distinction between the bottle cap 82 and the opening portion 87. In this configuration in which there is no distinction between the bottle cap 82 and the opening portion 87, the bottle cap 82 may have the protrusion 94 or the bottle cap 82 does not necessarily have the protrusion 94.

A single opening may be opened and closed by the valve 161. For example, the opening 96A, the bottle tube 96, and the communication ports 119 may be omitted. In this case, it is preferable that the tank tube 115 inserted in the opening 95 defines the air flow passage and the ink flow passage. In this case, the opening 95 is an example of the liquid supply port.

The bottle tube 96 is configured to be diagonally inserted into the corresponding communication port 119 in the extending direction. However, for example, the communication ports 119 may be provided on the upper wall 104, extending in the horizontal direction, and the ink bottle 80 may be inserted downward into the corresponding communication port 119 in the up-down direction. In this case, each tank tube 115 may extend upward.

What is claimed is:

1. A liquid container, comprising:
a body defining a storage chamber configured to store liquid;
a valve positioned inside the body, the valve being movable between a closed position and an open position;
a liquid supply port providing communication between an inside of the storage chamber and an outside of the storage chamber in a movement direction in which the valve moves, the liquid supply port being closed when the valve is at the closed position, the liquid supply port being open when the valve is at the open position;
an elastic member urging the valve to the closed position; and
a switching mechanism including:
a first spring seat supporting the elastic member; and
a support member supporting the first spring seat,
wherein the switching mechanism has a cylindrical shape and extends in the movement direction, and
wherein the switching mechanism is configured to switch an urging force with which the elastic member urges the valve between a first urging force and a second urging force smaller than the first urging force.

2. The liquid container according to claim 1,
wherein the switching mechanism switches the urging force from the first urging force to the second urging force in accordance with a movement of the valve from the closed position to the open position.

3. The liquid container according to claim 2,
wherein the elastic member is a first spring configured to expand and contract in the movement direction, and
wherein the first spring seat is configured to move in the movement direction from a first support position where the first spring seat supports the first spring such that the first spring urges the valve with the first urging force to a second support position where the first spring seat supports the first spring such that the first spring urges the valve with the second urging force in accordance with the movement of the valve from the closed position to the open position.

4. The liquid container according to claim 3,
wherein the support member supports the first spring seat such that the first spring seat is movable in the movement direction from the first support position to the second support position.

5. The liquid container according to claim 4,
wherein the support member supports the first spring seat such that the first spring seat is movable in the movement direction not only from the first support position to the second support position but also from the second support position to the first support position.

6. The liquid container according to claim 5,
wherein the first spring seat includes:
a support body supporting the first spring; and
a first guide piece protruding from the support body in a direction orthogonal to the movement direction,
wherein the first spring seat is rotatable about a center axis of the support member in a rotational direction, the center axis extending in the movement direction,
wherein the support member has:
a support portion supporting the first spring seat such that the first spring seat is movable in the movement direction and the first spring seat is rotatable about the center axis of the support member;
a first holding portion configured to contact the first guide piece to hold the first spring seat in the first support position;
a second holding portion configured to contact the support body to hold the first spring seat in the second support position; and
a first guide slit extending in the movement direction toward the second holding portion from a portion of the support member adjacent to one end portion of the first holding portion in the rotational direction, the first guide piece being movable in the movement direction inside the first guide slit, and
wherein the movement of the valve from the closed position to the open position causes the first spring seat to rotate in the rotational direction about the center axis of the support member to move the first guide piece into an inside of the first guide slit.

7. The liquid container according to claim 2,
wherein the elastic member is a first spring configured to expand and contract in the movement direction,
wherein the switching mechanism includes:
a second spring seat configured to support the first spring;
a first holding portion configured to hold the second spring seat such that the second spring seat is positioned at a first support position; and
a third spring seat configured to support the first spring, the third spring seat being at a second support position where the third spring seat is capable of supporting the first spring,
wherein, in a state where the second spring seat is held at the first support position by the first holding portion, the first spring is supported by the second spring seat such that the first spring urges the valve with the first urging force,
wherein the movement of the valve from the closed position to the open position causes the second spring seat to be detached from the first holding portion, and
wherein, in a state where the second spring seat is detached from the first holding portion, the first spring is supported by the third spring seat, which is at the second support position, such that the first spring urges the valve with the second urging force.

8. The liquid container according to claim 2,
wherein the elastic member includes a first rubber and a second rubber,
wherein the switching mechanism has a first support portion and a second support portion spaced apart from each other in a direction crossing the movement direction,
wherein the first rubber is press-fitted between the first support portion and the second support portion such that the first rubber urges the valve to the closed position with a third urging force,
wherein the second rubber is supported by at least one of the first support portion and the second support portion such that the second rubber urges the valve to the closed position with the second urging force,
wherein the first urging force is a sum of the third urging force and the second urging force, and
wherein the movement of the valve from the closed position to the open position causes the first rubber to be detached from between the first support portion and the second support portion.

9. The liquid container according to claim 2,
wherein the elastic member includes a first spring and a second spring which are configured to expand and contract in the movement direction,
wherein the switching mechanism includes:
a second spring seat configured to support the first spring;
a first holding portion configured to hold the second spring seat such that the second spring seat is positioned at a first support position; and
a third spring seat positioned at a second support position, the third spring seat supporting the second spring such that the second spring urges the valve with the second urging force,
wherein, in a state where the second spring seat is held at the first support position by the first holding portion, the first spring is supported by the second spring seat such that the first spring urges the valve with a third urging force,
wherein the first urging force is a sum of the second urging force and the third urging force, and
wherein the movement of the valve from the closed position to the open position causes the second spring seat to be detached from the first holding portion.

10. The liquid container according to claim 6,
wherein the first spring seat includes a second guide piece protruding from the support body in a direction orthogonal to the movement direction, the second guide piece being positioned at a position point-symmetrical to the first guide piece with respect to the center axis of the support member;
wherein the support member includes:
a third holding portion configured to contact the second guide piece to hold the first spring seat at the first support position; and
a second guide slit extending in the movement direction toward the second holding portion from a portion of the support member adjacent to one end portion of the third holding portion in the rotational direction, the second guide piece being movable in the movement direction inside the second guide slit, and
wherein the movement of the valve from the closed position to the open position causes the first spring seat to rotate in the rotational direction about the center axis of the support member to move the second guide piece into an inside of the second guide slit.

11. The liquid container according to claim 10, further comprising:
a second support member having a cylindrical shape, the second support member being positioned between the valve and an inner surface of the body,
wherein the second support member guides the movement of the valve between the closed position and the open position.

12. The liquid container according to claim 1,
wherein the body has an air inlet providing communication between the inside of the storage chamber and the outside of the storage chamber in the movement direction, and
wherein the valve is configured to close both the air inlet and the liquid supply port.

13. The liquid container according to claim 12, further comprising:
a nozzle protruding in the movement direction from the liquid supply port.

14. The liquid container according to claim 1,
wherein the body has:
a bottle main body having an opening portion defining an open end of the storage chamber; and
a bottle cap in which the liquid supply port is positioned, the bottle cap being attachable to and detachable from the opening portion, and
wherein the valve, the elastic member, and the switching mechanism are attached to the bottle cap.

15. The liquid container according to claim 14,
wherein the bottle cap has an air inlet and the liquid supply port, each of the air inlet and the liquid supply port providing communication between the inside of the storage chamber and the outside of the storage chamber in the movement direction,
wherein the liquid container is configured to be connected to a tank,
wherein the bottle cap has a protrusion configured to be inserted in a connection port, the connection port being disposed so as to face a liquid inlet disposed in the tank, and
wherein the protrusion has a rib protruding from an outer peripheral surface of the protrusion, the rib being configured to contact an inner surface of the connection port.

16. A liquid container, comprising:
a body defining a storage chamber configured to store liquid;
a valve positioned inside the body, the valve being movable between a closed position and an open position;
a liquid supply port providing communication between an inside of the storage chamber and an outside of the storage chamber in a movement direction in which the valve moves, the liquid supply port being closed when the valve is at the closed position, the liquid supply port being open when the valve is at the open position;
an elastic member urging the valve to the closed position; and
a switching mechanism configured to switch an urging force with which the elastic member urges the valve between a first urging force and a second urging force smaller than the first urging force.
